(19) United States
(12) Patent Application Publication
(10) Pub. No.: US 2025/0164797 A1
(43) Pub. Date: May 22, 2025

(54) ILLUMINATION SYSTEM INCLUDING ZONAL ILLUMINATION OPTICAL CONCENTRATORS

(71) Applicant: Meta Platforms Technologies, LLC, Menlo Park, CA (US)

(72) Inventors: Robert UPTON, Del Mar, CA (US); Jacques GOLLIER, Sammamish, WA (US); Fenglin PENG, Redmond, WA (US)

(21) Appl. No.: 18/937,002

(22) Filed: Nov. 4, 2024

Related U.S. Application Data
(60) Provisional application No. 63/601,207, filed on Nov. 20, 2023.

(51) Int. Cl. G02B 27/01

(52) U.S. Cl. CPC G02B 27/0172; G02B 2027/0178

(57) ABSTRACT

An illumination system for a non-emissive display panel is provided. The illumination system includes a light source array including a plurality of individually addressable illumination units, an illumination unit being configured to emit a first light beam having a first solid angle. The illumination system also includes a concentrator array coupled with the light source array and including a plurality of concentrators, a concentrator being configured to condition the first light beam into a second light beam associated with a second solid angle that is smaller than the first solid angle, the second light beam providing a substantially uniform illumination at an exit aperture of the concentrator. The illumination system also includes an imaging assembly including one or more optical elements configured to image the substantially uniform illumination at the exit aperture of the concentrator onto the non-emissive display panel.

### CROSS REFERENCE TO RELATED APPLICATION

This application claims the benefit of priority to U.S. Provisional Application No. 63/601,207, filed on Nov. 20, 2023. The content of the above-referenced application is incorporated by reference in its entirety.

### TECHNICAL FIELD

The present disclosure relates generally to optical systems and, more specifically, to an illumination system including zonal illumination optical concentrators.

### BACKGROUND

Display technologies have been widely used in a large variety of applications in daily life, such as smartphones, tablets, laptops, monitors, TVs, projectors, vehicles, virtual reality (“VR”) devices, augmented reality (“AR”) devices, mixed reality (“MR”) devices, etc. Non-emissive displays, such as liquid crystal displays (“LCDs”), liquid-crystal-on-silicon (“LCoS”) displays, or digital light processing (“DLP”) displays, may require a backlight unit to illuminate a display panel. Self-emissive displays may display images through emitting lights with different intensities and colors from light-emitting elements. A self-emissive display may also function as a locally dimmable backlight unit for a non-emissive display panel. A compact display engine with dynamic zonal brightness control that provides improved display performance and power budget is highly desirable. The compact display engine can be incorporated into a variety of devices, and is suitable for portable devices including hand-held, wrist-worn, or head-mounted devices, etc.

### SUMMARY OF THE DISCLOSURE

One aspect of the present disclosure provides an illumination system for a non-emissive display panel. The illumination system includes a light source array including a plurality of individually addressable illumination units, an illumination unit being configured to emit a first light beam having a first solid angle. The illumination system also includes a concentrator array coupled with the light source array and including a plurality of concentrators, a concentrator being configured to condition the first light beam into a second light beam associated with a second solid angle that is smaller than the first solid angle, the second light beam providing a substantially uniform illumination at an exit aperture of the concentrator. The illumination system also includes an imaging assembly including one or more optical elements configured to image the substantially uniform illumination at the exit aperture of the concentrator onto the non-emissive display panel.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of an artificial reality system, according to an example of the present disclosure;

FIG. 1B illustrates a schematic cross-sectional view of the artificial reality system shown in FIG. 1A, according to an example of the present disclosure;

FIG. 2A illustrates a schematic diagram of a display system, according to an example of the present disclosure;

FIG. 2B illustrates a schematic diagram of a light source array that may be included in the display system shown in FIG. 2A, according to an example of the present disclosure;

FIGS. 2C-2E illustrate schematic diagrams of color sub-zone configurations of an illumination unit that may be included in the light source array shown in FIG. 2B, according to an example of the present disclosure;

FIG. 2F illustrates a schematic diagram of an illumination unit and a concentrator that may be included in the display system shown in FIG. 2A, according to an example of the present disclosure;

FIG. 2G illustrates a schematic diagram of an illumination unit and a concentrator that may be included in the display system shown in FIG. 2A, according to an example of the present disclosure;

FIG. 3A illustrates schematic diagrams of a concentrator array and a concentrator that may be included in the display system shown in FIG. 2A, according to an example of the present disclosure;

FIG. 3B illustrates a schematic diagram of a concentrator that may be included in the display system shown in FIG. 2A, according to an example of the present disclosure;

FIG. 4 illustrates a schematic diagram of a concentrator array that may be included in the display system shown in FIG. 2A, according to an example of the present disclosure;

FIG. 5A illustrates a schematic diagram of a display system, according to an example of the present disclosure;

FIG. 5B illustrates a schematic diagram of a concentrator array and an illumination unit that may be included in the display system shown in FIG. 5A, according to an example of the present disclosure;

FIG. 6A illustrates a schematic diagram of a taper and an illumination unit that may be included in the display system shown in FIG. 2A, according to an example of the present disclosure;

FIG. 6B illustrates a top view of the taper and the illumination unit along the A-A′ line shown in FIG. 6A, according to an example of the present disclosure;

FIG. 6C illustrates simulation results showing output intensity of the taper shown in FIG. 6A, according to an example of the present disclosure;

FIG. 6D illustrates simulation results showing output intensity of the taper shown in FIG. 6A, via an elliptical mask, according to an example of the present disclosure;

FIG. 6E illustrates simulation results showing output intensity of the taper shown in FIG. 6A, via a rectangular mask, according to an example of the present disclosure;

FIG. 6F illustrates simulation results showing output intensity of a hollow taper, according to an example of the present disclosure;

FIG. 6G illustrates simulation results showing output intensity of a solid taper, according to an example of the present disclosure;

FIG. 7A illustrates a schematic diagram of a compound parabolic concentrator (“CPC”) and an illumination unit that may be included in the display system shown in FIG. 2A, according to an example of the present disclosure;

FIGS. 7B-7E illustrate simulation results showing output irradiance of the CPC shown in FIG. 7A, according to an example of the present disclosure;

FIGS. 7F-7I illustrate simulation results showing output intensity of the CPC shown in FIG. 7A, according to an example of the present disclosure;

FIG. 8A illustrates a schematic diagram of a taper that may be included in the display system shown in FIG. 2A, according to an example of the present disclosure;

FIGS. 8B-8E illustrate simulation results showing output irradiance of the taper shown in FIG. 8A, according to an example of the present disclosure; and

FIGS. 8F-8I illustrate simulation results showing output intensity of the taper shown in FIG. 8A, according to an example of the present disclosure.

### DETAILED DESCRIPTION

Various aspects of the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical devices refers to a configuration in which the two optical devices are arranged in an optical series, and a light output from one optical device may be directly or indirectly received by the other optical device. An optical series refers to optical positioning of a plurality of optical devices in a light path, such that a light output from one optical device may be transmitted, reflected, diffracted, converted, modified, or otherwise processed or manipulated by one or more of other optical devices. The sequence in which the plurality of optical devices are arranged may or may not affect an overall output of the plurality of optical devices. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” has a meaning similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

A key aspect of non-emissive optical projectors is to provide a uniform illumination field with smart optical source power management that is related to the content of images being projected. These non-emissive optical projectors are zonal illumination based systems, which may be referred to as zonal illuminated projectors or zonal illuminated projection systems. The present disclosure provides solutions for conditioning the lights emitted from backlight sources (e.g., standard light emitting diodes (“LEDs”), mini LEDs, or micro-LEDs, etc.) in space and angle to provide a substantially uniform illumination of the non-emissive display with a high optical efficiency. The solutions disclosed herein can lower the required optical power from the backlight sources, thereby extending the lifetime of the light sources and improving management of heat generated by the light sources.

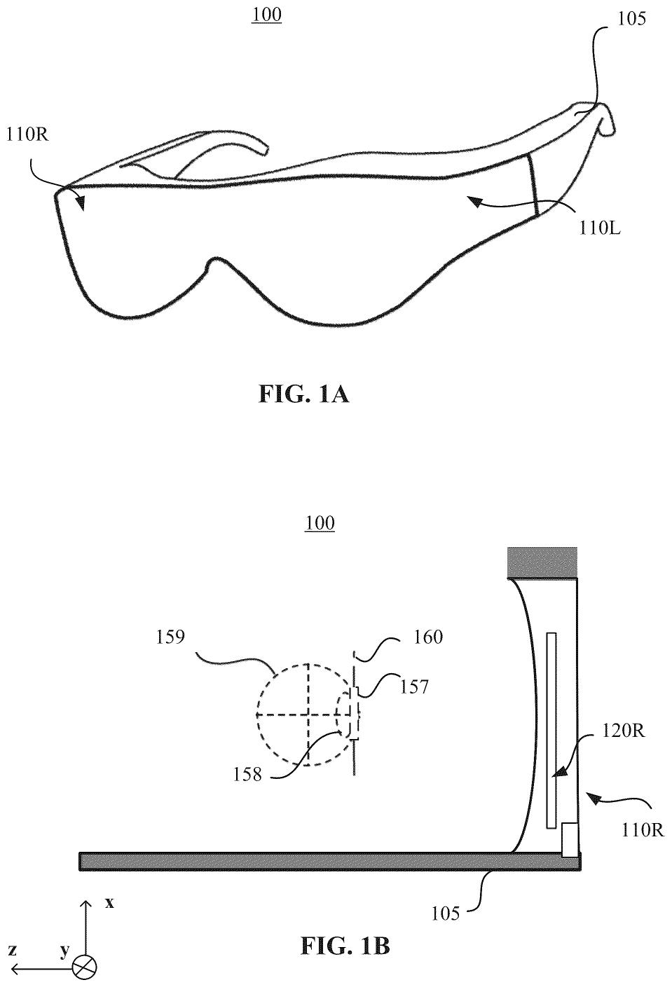

FIG. 1A illustrates a schematic diagram of an artificial reality system 100, according to an example of the present disclosure. The artificial reality system 100 may present virtual reality, augmented reality, and/or mixed reality content to a user, such as images, videos, audios, or a combination thereof. In some examples, the artificial reality system 100 may be configured to be worn on a head of a user (e.g., by having the form of spectacles or eyeglasses, as shown in FIG. 1A), or to be included as a part of a helmet that is worn by the user. In some examples, the artificial reality system 100 may be referred to as a head-mounted display. In some examples, the artificial reality system 100 may be configured for placement in proximity of an eye or eyes of the user at a fixed location in front of the eye(s), without being mounted to the head of the user. For example, the artificial reality system 100 may be mounted in a vehicle, such as a car or an airplane, at a location in front of an eye or eyes of the user.

For discussion purposes, FIG. 1A shows that the artificial reality system 100 includes a frame 105 configured to mount to a head of a user, and left-eye and right-eye display systems 110L and 110R mounted to the frame 105. The frame 105 is merely an example structure to which various components of the artificial reality system 100 may be mounted. Other suitable types of fixtures may be used in place of or in combination with the frame 105. The left-eye and right-eye display systems 110L and 110R may be customized to a variety of shapes and sizes to conform to different styles of the frame 105.

FIG. 1B is a cross-sectional view of half of the artificial reality system 100 shown in FIG. 1A according to an example of the present disclosure. For illustrative purposes, FIG. 1B shows the cross-sectional view associated with the right-eye display system 110R. The left-eye display system 110L may include the same or similar structure and components. Referring to FIG. 1B, the right-eye display system 110R of the artificial reality system 100 may include a right-eye viewing optics assembly 120R. The artificial reality system 100 may be configured to project a virtual image through an eye-box region 160 of the artificial reality system 100. The eye-box region 160 is a region in space where an eye 159 of the user may be positioned to perceive a virtual image. The eye-box region 160 may include one or more exit pupils 157. Each of the left-eye display system 110L and the right-eye display system 110R may include a display device (e.g., a projector) configured to generate an image light representing the virtual image, and the viewing optics assembly (e.g., 120R) may be configured to guide the image light to propagate through the one or more exit pupils 157. The projector may be configured to incorporate dynamic zonal brightness control, enhancing the display performance and power budget. Such a projector may be referred to as a zonal illuminated projector. An eye pupil 158 may be positioned at the one or more exit pupils 157 to perceive the virtual image generated by the zonal illuminated projector.

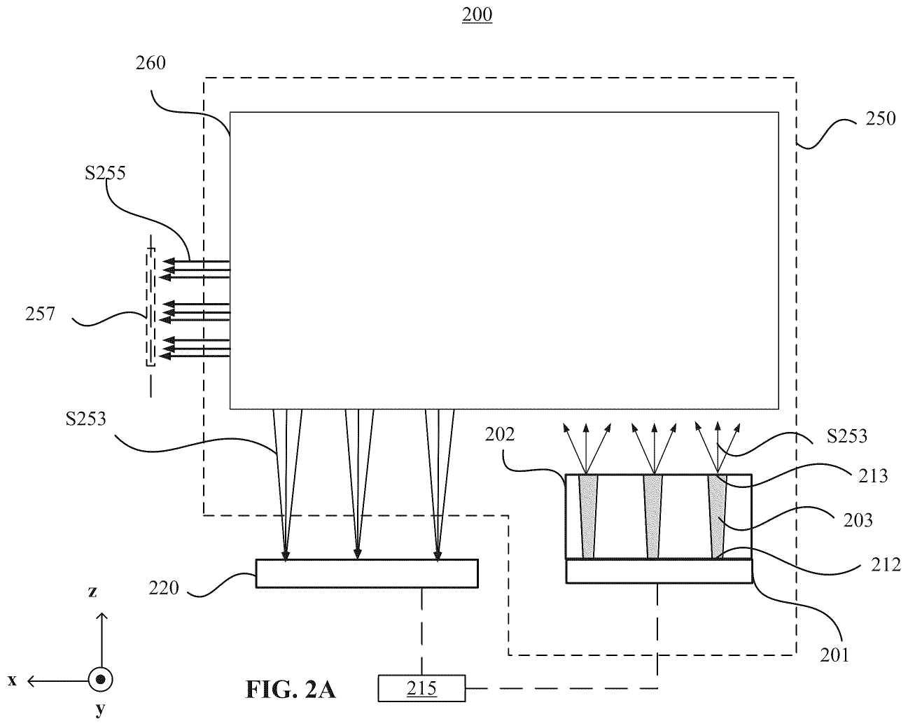

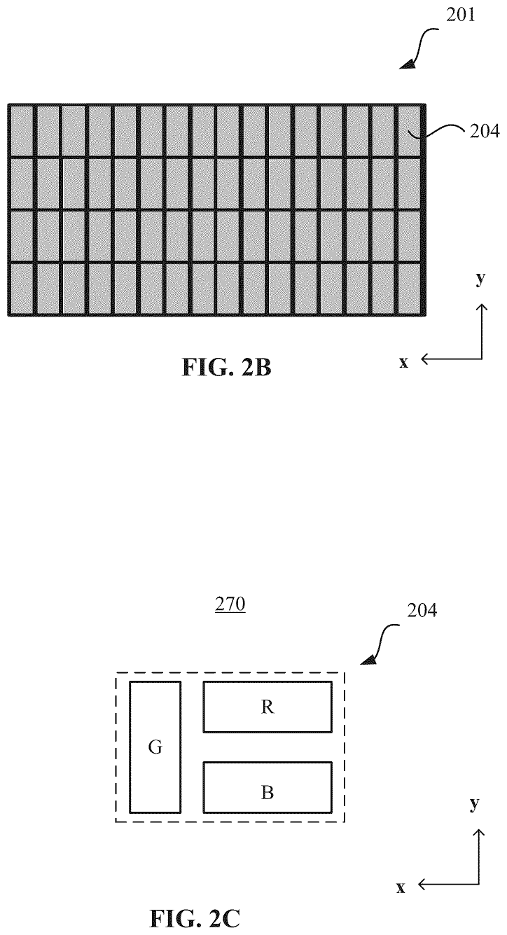

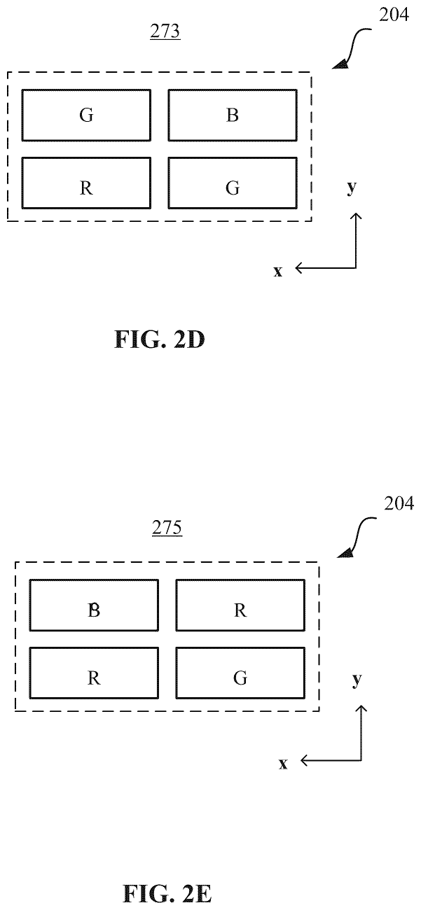

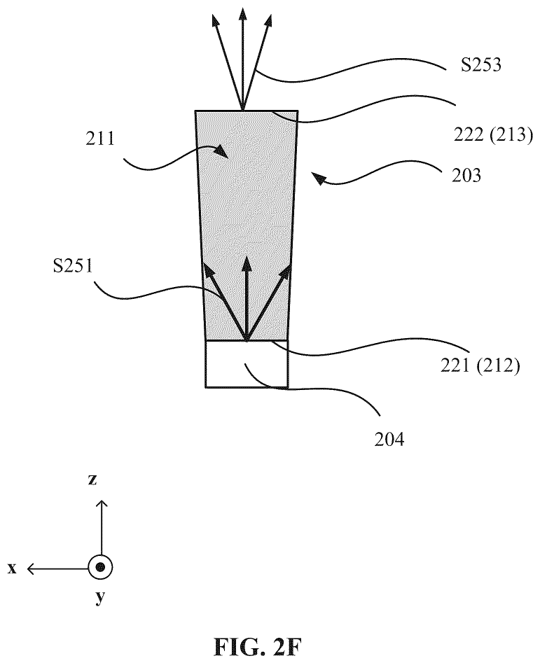

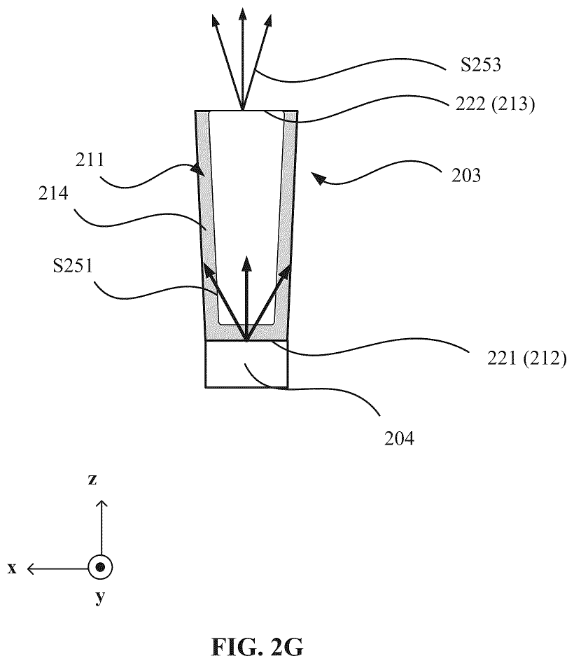

FIG. 2A illustrates an x-z sectional view of a display system 200 that may be included in an artificial reality system, according to an example of the present disclosure. The display system 200 may be an example of the left-eye display system 110L or the right-eye display system 110R shown in FIGS. 1A and 1B. The display system 200 may also be referred to as a zonal illuminated projector 200 (which may be referred to as “projector” for simplicity). The display system 200 may be configured to project a virtual image through the eye-box region 160. The display system 200 may be configured to incorporate dynamic zonal brightness control, enhancing both the display performance and the power budget.

As shown in FIG. 2A, the display system 200 may include an illumination assembly (or system) 250, a display panel 220, and a controller 215. The controller 215 may include any suitable hardware (e.g., processor, circuit, gate, switch, etc.) and software (e.g., program code, instruction, etc.) components specifically configured and/or programmed for controlling the illumination assembly 250 and the display panel 220. For example, the controller 215 may include a suitable processor, such as a central processing unit (“CPU”), a graphics processing unit (“GPU”), an application-specific integrated circuit (“ASIC”), a programmable logic device (“PLD”), or any combination thereof. The controller 215 may be electrically connected with the illumination assembly 250 and the display panel 220 through a wireless communication or a wired communication. The controller 215 may receive data, information, or signals from the illumination assembly 250 and/or the display panel 220, or may send data, information, or signals to the illumination assembly 250 and/or the display panel 220.

In some examples, the display panel 220 may be a non-emissive display panel, and the illumination assembly 250 may be configured to provide a zonal illumination to the display panel 220. The non-emissive display panel 220 may be a transmissive, reflective, or transflective non-emissive display panel, such as a reflective liquid crystal on silicon (“LCOS”) display panel, or a digital light processing (“DLP”) display panel, etc. Through the control of the controller 215, the illumination assembly 250 may provide a dynamic zonal illumination to the non-emissive display panel 220. The illumination assembly 250 disclosed herein may be applied to suitable zonal illuminated projectors having different configurations. Although the controller 215 is shown as an element separated from the illumination assembly 250, in some examples, the controller 215 may be included in the illumination assembly 250.

As shown in FIG. 2A, the illumination assembly 250 may include a light source array 201, a concentrator array 202, and an imaging assembly 260 arranged in an optical series. The concentrator array 202 may be coupled with the light source array 201, and may be disposed downstream of the light source array 201 in a light path along which a light propagates through the display system 200. The imaging assembly 260 may be coupled with the concentrator array 202, and may be disposed downstream of the concentrator array 202 in the light path. The controller 215 may be configured to control the operations of the light source array 201 and the display panel 220. The light source array 201 may emit a first backlight toward the concentrator array 202. The concentrator array 202 may condition the first backlight into a second backlight with a predetermined angular and spatial optical field distribution. The imaging assembly 260 may guide the second backlight to the non-emissive display panel 220, and image the predetermined angular and spatial optical field distribution onto the non-emissive display panel 220 for illumination.

FIG. 2B illustrates an x-y sectional view of the light source array 201 included in the display system 200 shown in FIG. 2A, according to an example of the present disclosure. As shown in FIGS. 2A and 2B, the light source array 201 may include a plurality of illumination units 204. A light source driving module or circuitry (not shown) may be included in the light source array 201 for driving the illumination units 204. The controller 215 may control the light source driving module or circuitry to individually address the illumination units 204, to provide a zonal illumination of the display panel 220. That is, each illumination unit 204 may be addressed by the light source driving module through the control of the controller 215. In some examples, the illumination units 204 may be divided into a plurality groups, each group may be individually addressable.

The concentrator array 202 may include a plurality of concentrators 203. The concentrators 203 may be non-imaging concentrators. Non-imaging concentrators may be configured to provide the transfer of light radiation between a source and a target without forming an optical image of the source (e.g., the light source array 201). Imaging concentrators may be configured to generate an optical image of the source (e.g., the light source array 201). In some examples, each of the concentrates 203 may correspond to one illumination unit 204 on a one-to-one basis. In some examples, each concentrator 203 may correspond to two or more illumination units 204. In some examples, as shown in FIG. 2A, the illumination unit 204 may be in direct contact with the corresponding concentrator 203 without a gap. In some examples, although not shown, the illumination unit 204 and the corresponding concentrator 203 may be spaced apart from one another by a predetermined gap.

Each illumination unit 204 may include a plurality of light sources configured to emit a plurality of lights of a plurality of primary colors that are mixed as a white light, such as one or more red light sources, one or more green light sources, and one or more blue light sources. In some examples, each illumination unit 204 may include one or more suitable light sources other than the red light sources, green light sources, and blue light sources. In some examples, the light source may include a light-emitting diode (“LED”), a mini-LED, or a micro-LED (“u-LED”). In some examples, the light source may include another suitable light source other than LED, such as a vertical-cavity surface-emitting laser (“VCSEL”), a photonic-crystal surface emitting laser or another suitable type of in-plane cavity surface emitting laser, a laser diode, a fiber laser, a heterogeneously integrated laser, or a superluminescent light emitting diode (“SLED”), etc.

FIGS. 2C-2E illustrate x-y cross sectional views of color sub-zone configurations of the illumination unit 204 that may be included in the light source array 201 shown in FIG. 2B, according to an example of the present disclosure. In some examples, each illumination unit 204 may include one or more red sub-zones corresponding to one or more red light sources, one or more green sub-zones corresponding to one or more green light sources, and one or more blue sub-zones corresponding to one or more blue light sources. In some examples, each illumination unit 204 may include one or more suitable color sub-zones other than the red sub-zone, the green sub-zone, and the blue sub-zone.

Using red (R), green (G), and blue (B) colors as examples, the color sub-zone configuration of the illumination unit 204 may take various forms, such as the RGB form shown in FIG. 2C, the RGGB form shown in FIG. 2D, and the RRGB form shown in FIG. 2E. These configurations are merely some example configurations that may be adopted for each illumination unit 204. Different configurations may provide different optical properties. As shown in FIG. 2C, a color sub-zone configuration 270 may include three color sub-zones corresponding to three light sources: a green sub-zone corresponding to a green light source (e.g., a green LED), a red sub-zone corresponding to a red light source (e.g., a red LED), and a blue sub-zone corresponding to a blue light source (e.g., a blue LED). The three light sources may have different sizes, e.g., the red light source (e.g., red LED) and the blue light source (e.g., blue LED) may have substantially the same size, which may be different from the size of the green light source G (e.g., green LED).

As shown in FIG. 2D, a color sub-zone configuration 273 may include four color sub-zones corresponding to four light sources: a red sub-zone corresponding to a red light source (e.g., a red LED), a blue sub-zone corresponding to a blue light source (e.g., a blue LED), and two green sub-zones corresponding to green light sources (e.g., two green LEDs). The four light sources may be arranged in a two by two array, and the four light sources may have substantially the same size. The color sub-zone configuration 273 may provide an enhanced green uniformity and an increased aspect ratio for polarization recovery within the illumination zone.

As shown in FIG. 2E, a color sub-zone configuration 275 may include four color sub-zones corresponding to four light sources: a green sub-zone corresponding to a green light source (e.g., a green LED), a blue sub-zone corresponding to a blue light source (e.g., a blue LED), and two red sub-zones corresponding to two red light sources (e.g., two red LEDs). The four light sources may be arranged in a two by two array, and the four light sources may have substantially the same size. The color sub-zone configuration 275 may alleviate the current density demands on the red light sources (e.g., red LEDs), which typically have the lowest wall-plug efficiency (“WPE”) and the highest current density.

FIG. 2F illustrates an x-z cross sectional view of one of the illumination units 204 and one of the concentrators 203 that may be included in the display system shown in FIG. 2A, according to an example of the present disclosure. For discussion purposes, FIG. 2F shows that each concentrator 203 corresponds to each illumination unit 204. As shown in FIG. 2F, the concentrator 203 may have an input or entrance facet 221 at a light entering portion (e.g., where an input or entrance aperture 212 of the concentrator 203 is located), an output or exit facet 222 at a light exiting portion (e.g., where an output or exit aperture 213 of the concentrator 203 is located). The illumination unit 204 may be disposed adjacent to or at the input or entrance facet 221 (or the input or entrance aperture 212).

The input facet 221 may have a smaller area (or size) than the output facet 222, which is shown as having a smaller x-axis dimension than the output facet 222 in the x-z cross section. For example, when the input facet 221 and the output facet 222 each have a circular x-y cross section, a diameter of the input facet 221 may be smaller than a diameter of the output facet 222. When the input facet 221 and the output facet 222 each have a square x-y cross section, a length of the four sides of the square for the input facet 221 may be smaller than a length of the four sides of the square for the output facet 222. When the input facet 221 and the output facet 222 each have an elliptical, rectangular, or other suitable shapes in the x-y cross section, an overall area of the input facet 221 may be smaller than an overall area of the output facet 222.

The concentrator 203 may also include a concentrator body 211 located between the input facet 221 and the output facet 222. In some examples, the concentrator body 211 may have a roughly cylindrical or prism shape having a gradually increasing x-y cross-sectional area (or length, width, radius, or diameter, etc.) in a thickness direction of the concentrator body 211 (e.g., the z-axis direction from the input facet 221 to the output facet 222). The concentrator body 211 having the roughly cylindrical or prism shape may also be referred to as an angularly shaped concentrator body. A side surface (also referred to as an outer side surface or outer surface) of the angularly shaped concentrator body may extend in the z-axis direction (or longitudinal direction) as a straight surface. When the concentrator body 211 has a straight side surface in the longitudinal direction, the x-z cross sectional view of the straight side surface of the concentrator body 211 may be represented by straight lines on the left and right sides, as shown in FIG. 2F. In some examples, in the x-z cross sectional view, the straight lines of the straight side surface of the concentrator body 211 may form a tilt angle (e.g., an acute angle) with respective to a central axis of symmetry of the concentrator body 211 (e.g., the z-axis that passes through a geometric center of the concentrator body 211).

In some examples, the side surface of the concentrator body 211 may extend in the z-axis direction (or longitudinal direction) as a curved surface. When the concentrator body 211 has a curved side surface in the longitudinal direction, the x-z cross sectional view of the curved side surface of the concentrator body 211 may be represented by two curved lines on the left and right sides. The curved lines may be based on any suitable curves, such as parabolic curves, etc.

In some examples, although not shown in FIG. 2F, the concentrator body 211 may include a first body portion that is an angularly shaped body portion (or a curved body portion) and a second body portion that is a straight body portion. The straight body portion may be perpendicular to the output facet 222. The straight body portion may have a roughly cylindrical (or prism) shape having a constant x-y cross-sectional area in the thickness direction of the concentrator body 211 (e.g., the z-axis direction from the input facet 221 to the output facet 222).

The concentrator body 211 may have a suitable 3D shape, such as a truncated pyramid shape, a truncated cone shape, or a truncated paraboloid shape, etc. In the example shown in FIG. 2F, the x-z cross sectional view of the concentrator body 211 shows a trapezoidal shape. It is understood that the trapezoidal shape shown in the x-z cross sectional view may represent a cross section of a 3D truncated pyramid shape or a 3D truncated cone shape. For convenience of discussion, when the concentrator body 211 has a 3D truncated pyramid shape, the trapezoidal shape in the x-z cross sectional view may also be referred to as a truncated pyramid-shape cross section, and when the concentrator body 211 has a 3D truncated cone shape, the trapezoidal shape in the x-z cross sectional view may also be referred to as a truncated cone-shape cross section. A cross section of the concentrator body 211 in a plane (e.g., an x-y plane) perpendicular to the thickness direction (e.g., the z-axis direction) of the concentrator body 211 may have a suitable shape, such as a circular shape, an elliptical shape, a rectangular shape, or a square shape, etc. Accordingly, the input facet 221 and the output facet 222 may have any suitable shape, such as a circular shape, an elliptical shape, a rectangular shape, or a square shape, etc.

Referring to FIG. 2A and FIG. 2F, in some examples, in the concentrator array 204, a space surrounding the concentrator 203 may be filled with air. In some examples, a space surrounding the concentrator 203 may be filled with an isotropic and homogeneous dielectric material having an isotropic and homogenous refractive index that is smaller than the refractive index of the air. The light source array 201 including the illumination units 204 may be configured to emit a plurality of first light beams S251 (shown in FIG. 2F) toward the concentrator array 202. The illumination unit 204 may be located adjacent to (e.g., substantially close to) the entrance aperture 212 of the corresponding concentrator 203. The concentrator array 202 may be configured to condition the first light beams S251 into corresponding second light beams S253 each having a predetermined angular and spatial optical field distribution at the exit aperture 213 of the concentrator 203. In some examples, each of the second light beams S253 may have the same predetermined angular and spatial optical field distribution at the exit aperture 213.

In some examples, the first light beam S251 emitted from the illumination unit 204 may have a wide angular emission, while the second light beam S253 output from the concentrator 203 may have a narrow angular emission that is etendue matched to the imaging assembly 260. In some examples, the first light beam S251 may have a first solid angle in the three-dimensional space, and the second light beam S253 may have a second solid angle in the three-dimensional space, which is smaller than the first solid angle. Moreover, the second light beam S253 may have a substantially uniform illumination at the exit aperture 213 of the concentrator 203.

The imaging assembly 260 may include one or more illumination relay optical elements, such as one or more polarization beam splitters, one or more mirrors (e.g., curved mirrors), one or more lenses, etc. The imaging assembly 260 may also be referred to as an illumination relay optical assembly 260. The imaging assembly 260 may guide and focus the second light beam S253 onto the non-emissive display panel 220 to illuminate the non-emissive display panel 220. That is, the imaging assembly 260 may image the substantially uniform illumination (or irradiance distribution) provided at the exit apertures 213 of the concentrators 203 onto the non-emissive display panel 220. Thus, the non-emissive display panel 220 may be illuminated by the substantially uniform illumination (or irradiance distribution) that is originally provided at the exit apertures 213 of the concentrators 203.

The non-emissive display panel 220 may modulate the second light beam S253 into an image light beam S255 (e.g., including a bundle of parallel rays) representing a portion of a virtual image displayed by the non-emissive display panel 220. In some examples, the imaging assembly 260 may also guide the image light beam S255 toward an input pupil 257 of a viewing optics assembly (e.g., the viewing optics assembly 120R shown in FIG. 1B). The viewing optics assembly may guide the image light beam S255 to propagate through an eye-box region of the artificial reality system.

In the example shown in FIG. 2F, the concentrator 203 is a solid concentrator, which may be substantially entirely made of an isotropic and homogeneous dielectric material having an isotropic and homogenous refractive index. That is, substantially the entire concentrator body may be a solid piece. FIG. 2G illustrates an x-z cross sectional view of one of the illumination units 204 and one of the concentrators 203 that may be included in the display system shown in FIG. 2A, according to an example of the present disclosure. In the example shown in FIG. 2G, the concentrator 203 may have a hollow design, in which a cavity is created within the concentrator body 211. That is, the concentrator body 211 may include a cavity surrounded by a wall 214. The wall 214 may be configured such that the cavity has a suitable shape described herein, such as the truncated cone shape, the truncated pyramid shape, the truncated paraboloid shape, etc. The shape of the cavity and/or the wall 214 of the hollow concentrator may be configured to enable multiple reflections to occur to the light beam propagating within the cavity due to the reflective properties of the wall 214 surrounding the cavity, which may result in high etendue matching.

In the solid concentrator design shown in FIG. 2F, the material of the concentrator body 211 may be selected to achieve total internal reflection (“TIR”) to optically condition the light beam. The solid concentrator may be configured to provide TIR for highly efficient optical in-coupling and for confining the light beam within the concentrator 203 until the light beam exits the concentrator 203 at the exit aperture 213. In the solid concentrator design shown in FIG. 2F, the optical losses due to the Fresnel transmissions at otherwise non-TIR angles may be substantially small, e.g., close to zero.

In the solid and hollow concentrator designs shown in FIG. 2F and FIG. 2G, the concentrator 203 may include one or more suitable materials, such as cyclic olefin copolymer (“COC”), cyclic olefin polymer (“COP”), polycarbonate (“PC”), polymethyl methacrylate (“PMMA”), polyethylene (“PE”), polyurethane, or polypropylene (“PP”), etc. In some examples, an anti-reflection coating may be disposed at the input facet 221 and the output facet 222 of the concentrator 203. As the light beam is confined within the concentrator 203 via TIR, the anti-reflection coating may not be needed at the side surface of the concentrator 203.

In the solid and hollow designs, the concentrator 203 may be designed based on optical etendue and other system considerations. The entrance aperture (or input aperture) 212 of the concentrator 203 may have an area of A (Dᵢₓ, D_{iy}), where Dᵢₓ and D_{iy} are dimensions of the entrance aperture 212 within a plane (e.g., an x-y plane) that is perpendicular to a thickness direction (e.g., a z-axis direction) of the concentrator 203. The exit aperture (or output aperture) 213 of the concentrator 203 may have an area of A (Dₒₓ, D_{oy}), where Dₒₓ and D_{oy} are dimensions of the exit aperture 213 within the plane (e.g., x-y plane) that is perpendicular to the thickness direction (e.g., z-axis direction) of the concentrator 203. It is noted that many working principles described herein using a solid concentrator as an example may also be applied to a hollow concentrator.

Each of the entrance aperture 212 and the exit aperture 213 may have a suitable shape in the x-y cross section. In some examples, each of the entrance aperture 212 and the exit aperture 213 may have a circular shape, and Dᵢₓ and D_{iy} may be the same, which may be the diameter of the circular shape, and correspondingly, Dₒₓ and D_{oy} may be the same, which may be the diameter of the circular shape. In some examples, each of the entrance aperture 212 and the exit aperture 213 may have an elliptical shape, and Dᵢₓ and D_{iy} (and/or Dₒₓ and D_{oy}) may be the lengths along the major axis and the minor axis of the elliptical shape, respectively. In some examples, each of the entrance aperture 212 and the exit aperture 213 may have a rectangular or square shape, and Dᵢₓ and D_{iy} (and/or Dₒₓ and D_{oy}) may be the length and the width of the rectangular or square shape, respectively. The entrance aperture 212 with the dimensions Dᵢₓ and D_{iy} and the exit aperture 213 with the dimensions Dₒₓ and D_{oy} may have the basic etendue property:

$$A ( {D}_{ox} , {D}_{oy} ) {Ω}_{o} = η A ( {D}_{ix} , {D}_{i y} ) {Ω}_{i} ,$$

where Ωₒ is an output projected solid angle of an output beam of the concentrator 203, Ωᵢ is an input projected solid angle of an input beam of the concentrator 203, and n is an optical efficiency of the concentrator 203.

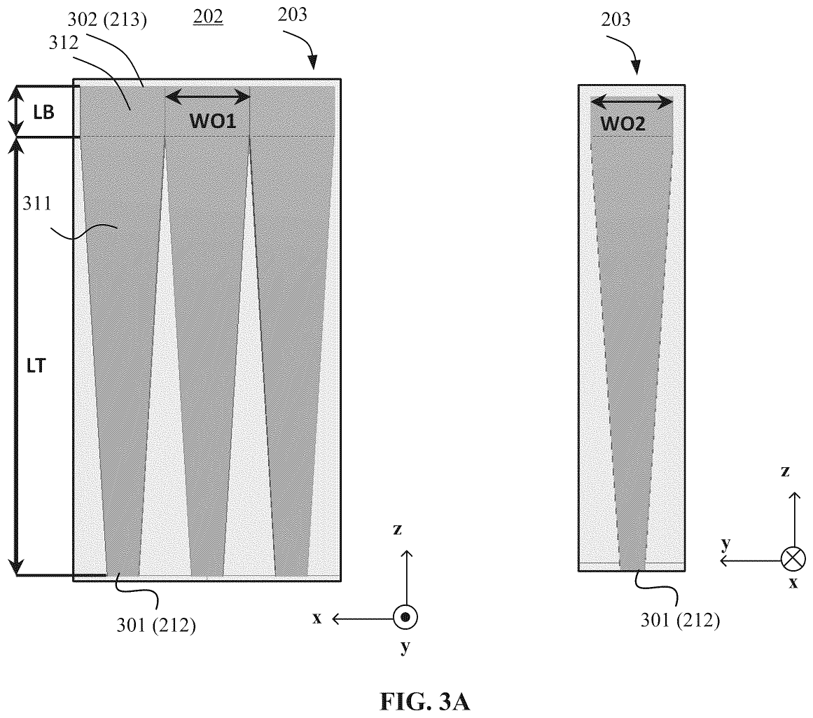

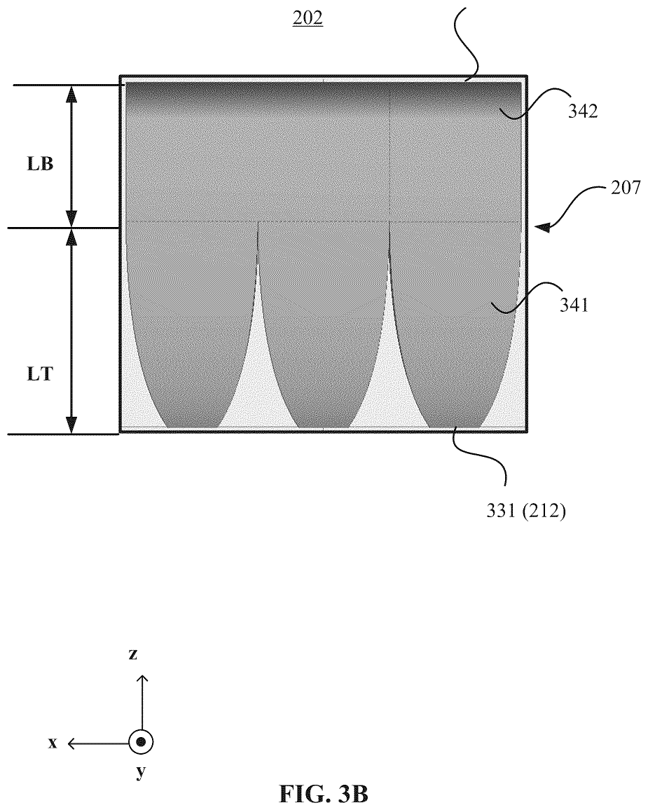

For discussion purposes, the present disclosure provides two examples of the concentrator array 202: a taper array and a compound parabolic concentrators (“CPC”) array. FIG. 3A illustrates an x-z sectional view of the concentrator array 202 including an array of three tapers 203 and a y-z sectional view of one of the tapers 203 included in the concentrator array 202, according to an example of the present disclosure. The number of tapers 203 may be configured to be any suitable number, such as more than three. A solid taper design is shown as an example. It is understood that some principle described below may also be applied to a hollow taper design. The array of tapers 203 may be configured to provide excellent illumination uniformity and color mixing properties, and an emission having elliptical and rotational angular distributions. In some examples, the array of tapers 203 may be configured to provide a circular or elliptical intensity distribution that matches the circular or elliptical aperture of the exit pupil of the display system 200 (shown in FIG. 2A). Through this configuration, a highly uniform illumination with etendue matching may be provided to the non-emissive display panel 220. Further, the solid tapers 203 may provide optical in-coupling with TIR.

In some examples, each taper 203 in the concentrator array 202 may have similar or the same structure. Thus, for convenience of discussion, the structure of one taper 203 is described below. Each taper 203 may include an input or entrance facet 301 (where the entrance aperture 212 is located) at a light entering portion, and an output or exit facet 302 (where the exit aperture 213 is located) at a light exiting portion. In some examples, the x-y cross sectional area of the input facet 301 may be smaller than the x-y cross sectional area of the exit facet 302. At least one dimension of the input facet 301 (or the entrance aperture 212) may be smaller than at least one dimension of the output facet 302 (or the exit aperture 213). For example, as shown in FIG. 3A, in the x-z cross sectional view shown on the left, a width or diameter of the input facet 301 in the x-axis direction may be smaller than a width or diameter of the output facet 302 in the x-axis direction.

The concentrator body 211 (shown in FIG. 2F) of the taper 203 may be formed by a first body portion 311 and a second body portion 312, as in the example shown in FIG. 3A. In some examples, the first body portion 311 and the second body portion 312 may be two virtually divided body portions of an integral single piece made with a same material, and the division between the two body portions represented by the dashed line in FIG. 3A may be merely for illustration purposes and for the convenience of description. In some examples, the first body portion 311 and the second body portion 312 may be two separate or individual body portions disposed or coupled together to form the concentrator body 211. For discussion purposes, the taper 203 is described as a single piece that is virtually divided into the first body portion 311 and the second body portion 312 for the convenience of description.

The first body portion 311 is located between the input facet 301 and the second body portion 312, and the second body portion 312 is located between the first body portion 311 and the output facet 302. In some examples, the second body portion 312 may be omitted. The first body portion 311 may include a longitudinally extended 3D body that extends in the z-axis direction. The first body portion 311 may be an angularly shaped body portion and the second body portion 312 may be a straight body portion (e.g., a cylinder or prism type). The angularly shaped body portion may be a 3D truncated cone shape or a 3D truncated pyramid shape, which may have a substantially trapezoidal cross section in the x-z cross sectional view, with a height of LT in the z-axis direction (i.e., the height direction of the concentrator 203). The x-y cross section of the first body portion 311 may have a circular shape, an elliptical shape, a rectangular shape, a square shape, or any other suitable shapes. The straight body portion may have a cylindrical (circular or elliptical), cubic, cuboidal shape, or other suitable 3D shape, with a height of LB in the z-axis direction. The x-y cross section of the second body portion 312 may have a circular shape, an elliptical shape, a rectangular shape, a square shape, or any other suitable shapes, with a length of WO1 in the x-axis direction and a length of WO2 in the y-axis direction.

The taper 203 may be configured to enable multiple reflections (e.g., total internal reflections) of the first light beam S251 propagating therein. For example, referring to FIG. 2F and FIG. 3A, the input facet 301 (or the entrance aperture 212) may couple, via refraction, the first light beam S251 into a TIR propagation path inside the taper 203. The first light beam S251 coupled into the taper 203 may undergo multiple reflections at the side surface toward the output facet 302 (or the exit aperture 213). The output facet 302 (or the exit aperture 213) may couple, via refraction, the first light beam S251 out of the taper 203. In some examples, to introduce the TIR coupling of the first light beam S251 (e.g., a u-LED light beam) into the taper 203 (e.g., a PMMA taper), the taper 203 and the illumination unit 204 (e.g., u-LEDs) may be spaced apart from one another by a predetermined gap.

In some examples, an anti-reflection coating may be disposed at the input facet 301 and the output facet 302 of the taper 203. As the light beam is confined within the taper 203 via TIR, the anti-reflection coating may not be disposed at the side surface. Embedding the illumination unit 204 (e.g., u-LEDs) directly into the taper 203 without an anti-reflection coating may result in non-TIR losses, causing degradation in the optical efficiency of the taper 203. Moreover, the taper 203 may be configured with a minimum length for adequate etendue conservation. In some examples, the taper 203 may be configured with a height that is about 5 to 7 times of the dimension (e.g., length, width, radius, or diameter, etc.) of the exit aperture 213.

FIG. 3B illustrates an x-z sectional view of the concentrator array 202, according to an example of the present disclosure. As shown in FIG. 3B, the concentrator array 202 may include an array of CPCs 207. For illustrative purposes, FIG. 3B shows three CPCs 207. The CPC207 including an optically appended optical light bar may provide an optimum etendue matching and mapping to a rectangular angular output. In some examples, the array of CPCs 207 may be configured to provide a rectangular or square intensity distribution that matches the rectangular or square aperture of the exit pupil of the display system 200 (shown in FIG. 2A). In the example shown in FIG. 3B, the CPC 207 is shown as a solid CPC. Although not shown in the figures, similar to the examples shown in FIG. 2F and FIG. 2G, the CPC may alternatively have a hollow design. It is understood that some principles described herein based on the solid example CPC may also be applied to the hollow CPC design.

Each of the CPCs 207 included in the concentrator array 202 may have the same or similar structure. Thus, the structure of a single CPC is described. Each CPC 207 may include an input or entrance facet 331 at a light entering portion (e.g., where the entrance aperture 212 is located), an output or exit facet 332 at a light exiting portion (e.g., where the exit aperture 213 is located). The concentrator body 211 (shown in FIG. 2F) of each CPC 207 may be formed by a first body portion 341 and a second body portion 342. The first body portion 341 and the second body portion 342 may be virtually divided body portions for illustration and convenience of descriptions, or may be separate body portions that are disposed together to form the concentrator body 211. In some examples, the second portion 342 may be omitted.

The first body portion 341 may be referred to as a curved body portion and the second body portion 342 may be referred to as a straight body portion (e.g., a cylinder or prism type). In some examples, the straight body portion may also be referred to a flat light bar. In some examples, the first body portion 341 may be a 3D body with a side surface that is curved along a thickness direction (e.g., a z-axis), such as a truncated paraboloid shape. The x-z cross section of the curved first body portion 341 may show a curved outer boundary along the z-axis direction. When the first body portion 341 has a 3D truncated paraboloid shape, the x-z cross section of the curved first body portion 341 may show an outer boundary having a truncated parabolic shape (e.g., the left and right parabolic curves) with a height of LT in the z-axis direction. In some examples, the second body portion 342 may have a cylindrical (circular or elliptical), prism, cubic, or cuboidal shape, or any other suitable 3D shapes. Correspondingly, the second body portion 342 may have a circular, elliptical, rectangular, or square shape in the x-z cross section view with a height of LB in the z-axis direction. The x-y cross section of the curved first body portion 341 may have a circular, elliptical, rectangular, or square shape, or any other suitable shapes.

The CPC 207 may enable a nominally single reflection of (e.g., a single total internal reflection) of the first light beam S251 propagating therein. For example, referring to FIG. 2F and FIG. 3B, the first light beam S251 may enter the CPC 207 through the input facet 331 (or the entrance aperture 212), undergo a single reflection at the curved first body portion 341, propagate through the first body portion 341 and the second body portion 342, and subsequently exit the CPC 207 through the output facet 332 (or the exit aperture 213).

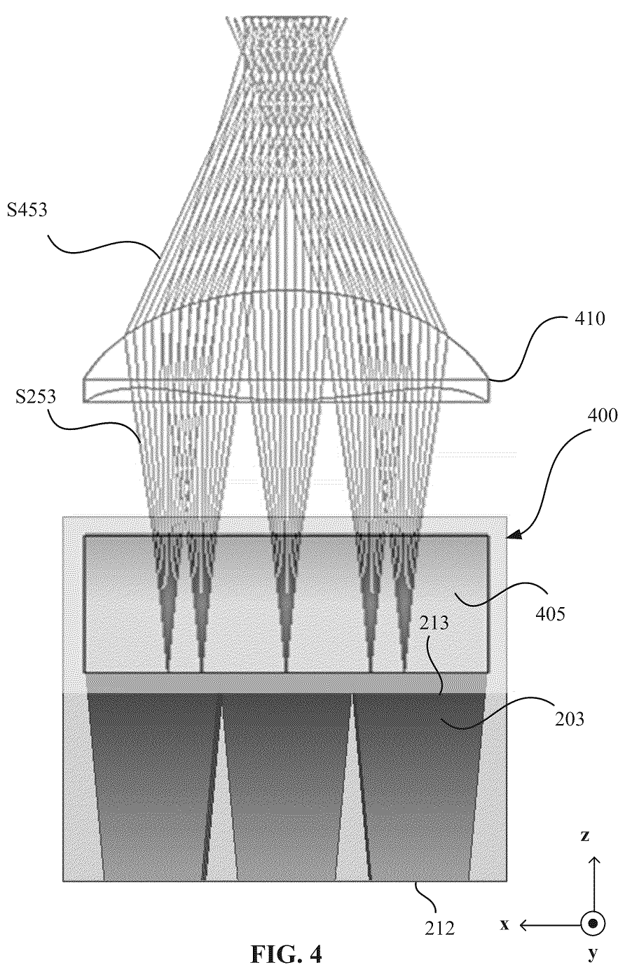

FIG. 4 illustrates an x-z sectional view of a concentrator array 400 that may be included in the display system 200 shown in FIG. 2A, according to an example of the present disclosure. The concentrator array 400 may be an example of the concentrator array 202 shown in FIG. 2A. Although the tapers 203 are used as examples of the concentrators in FIG. 4, it is understood that, in some examples, the tapers 203 may be replaced by the CPCs 207. Also, although solid concentrators are used as examples, the concentrators may have hollow designs. As shown in FIG. 4, the concentrator array 400 may include a monolithic element 405 located at the exit apertures 213 of the concentrators 203. The monolithic element 405 may allow for the simultaneous manufacture of the concentrators 203 in a 2D array. Referring to FIG. 2A and FIG. 4, the plane located at the exit aperture 213 of the concentrators 203 may be imaged onto the non-emissive display panel 220 via the imaging assembly 260 for zonal illumination. For discussion purposes, FIG. 4 shows that a collector 410 (e.g., a collection lens) included in the imaging assembly 260 may be configured to convert the second light beams S253 (e.g., divergent light beams) output from the concentrators 203 into a plurality of collimated light beams S453. Each collimated light beam S453 may include a bundle of parallel rays.

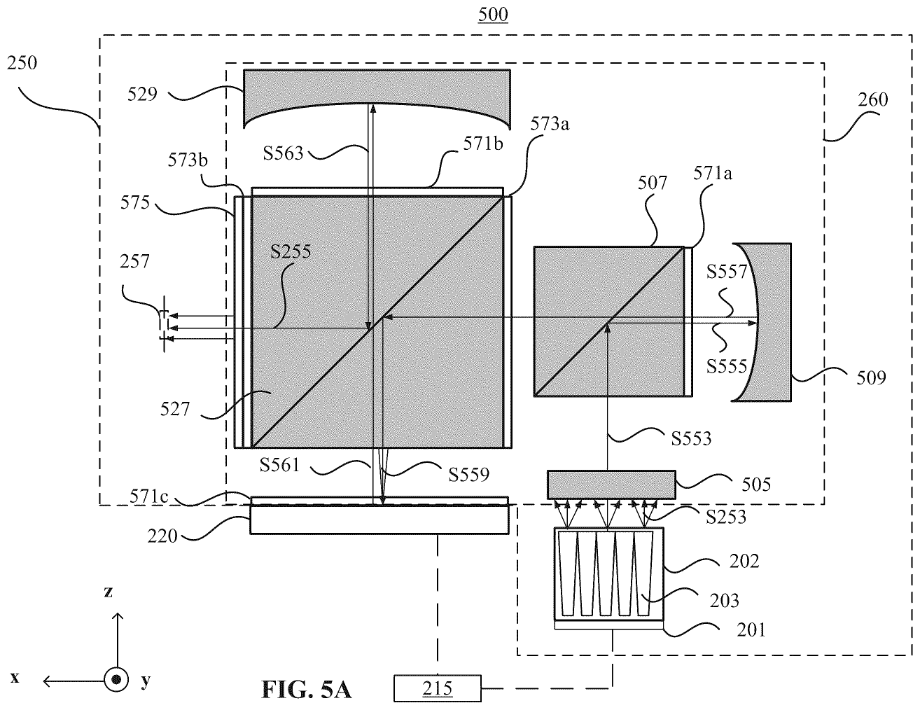

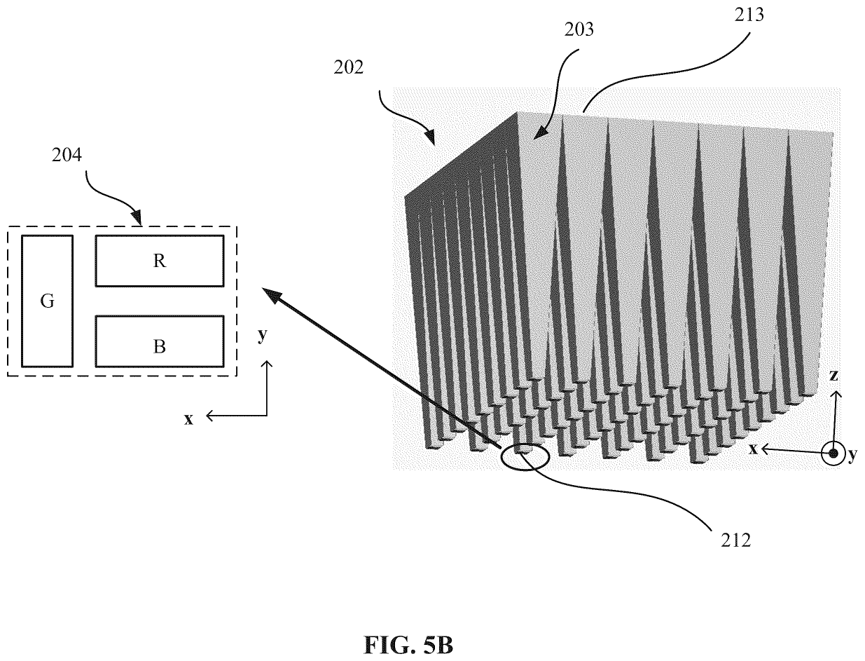

FIG. 5A illustrates an x-z cross sectional view of a display system 500, according to an example of the present disclosure. The display system 500 may be an example of the display system 200 shown in FIG. 2A. As shown in FIG. 5A, the display system 500 may include the illumination assembly 250 and the display panel 220. The illumination assembly 250 may include the light source array 201, the concentrator array 202, and the imaging assembly 260. Although tapers 203 are used as example concentrators, it is understood that, in some examples, the tapers 203 may be replaced by the CPCs 207. Also, although solid concentrators are used as examples, the concentrators may have hollow designs. The imaging assembly 260 may include a collector 505 (which may be similar to the collector 410), a first polarization beam splitter (“PBS”) 507, a second PBS 527, a first curved mirror 509, and a second curved mirror 529. The imaging assembly 260 may include other suitable elements, such as one or more polarization conversion elements. The collector 505 may be disposed between the concentrator array 202 and the first PBS 507. The first PBS 507 may be disposed between the second PBS 527 and the first curved mirror 509. The second PBS 527 may be disposed between the first PBS 507 and the second curved mirror 529, and between the second curved mirror 529 and the display panel 220.

FIG. 5B illustrates a diagram of the concentrator array 202 and an enlarged diagram of the illumination unit 204 included in the light source array 201. As shown in FIGS. 5A and 5B, each illumination unit 204 may be located adjacent to (e.g., substantially close to) each entrance aperture 212 of the concentrator array 202. Each illumination unit 204 may be configured to emit a backlight beam (e.g., the light beam S251 shown in FIG. 2F) toward the concentrator array 202. The concentrator array 202 may be configured to convert the backlight beams received from the illumination units 204 into the light beams S253, each of which may have a predetermined beam profile (including, e.g., a predetermined angular range and a predetermined illumination distribution) at each exit aperture 213 of the concentrator array 202. The backlight beam S253 may be a divergent backlight beam in which rays are confined within the predetermined angular range of the predetermined beam profile. For discussion purposes, FIG. 5A merely shows three backlight beams S253 respectively converted from backlight beams emitted from different illumination units 204 of the light source array 201, and three rays of each light beam S251. For discussion purposes, FIG. 5A merely shows the light prorogation path of a central ray of a central light beam S253 throughout the display system 500.

As shown in FIG. 5A, the collector 505 may include a collection lens configured to converge the light beam S253 output from the concentrator array 202 into a light beam S553 propagating toward the first PBS 507. The first PBS 507 may be configured to reflect the light beam S553 as a light beam S555 propagating toward the first curved mirror 509. The first curved mirror 509 may be configured to convert the light beam S555 into a light beam S557, which may be a convergent beam, while reflecting the light beam S555 as the light beam S557 back toward the first PBS 507. The first PBS 507 may substantially transmit the backlight beam S557 toward the second PBS 527. The second PBS 527 may substantially reflect the light beam S557 as a light beam S559 that propagates toward the display panel 220 and is focused onto the display panel 220. A combination of the respective light beams S559 may form a backlight that illuminates the display panel 220. The collector 505, the first PBS 507, and the first curved mirror 509 together may image the predetermined illumination distribution at the exit apertures 213 of the concentrator array 202 at the display panel 220 (or may form an image of the predetermined illumination distribution at the exit apertures 213 of the concentrator array 202 at the display panel 220), thereby illuminating the display panel 220.

For discussion purposes, in FIG. 5A, the display panel 220 may include a reflective LCOS panel. The display panel 220 may include a reflective pixel array facing the second PBS 527. The display panel 220 may be illuminated by the light beam S559, and may modulate and reflect the light beam S559 into an image light beam S561 that represents a virtual image generated by the display panel 220. For example, respective display zones of the display panel 220 may modulate and reflect the respective backlight beams S559 incident onto the display zones as respective image light beams S561. A combination of the respective image light beams S561 may form the image light that represents the entire virtual image generated by the display panel 220. The second PBS 527 may substantially transmit the image light beam S561 toward the second curved mirror 529, and the second curved mirror 529 may convert the image light beam S561 into an image light beam S563 (which may be a collimated light beam) back to the second PBS 527. The second PBS 527 may substantially reflect the image light beam S563 as the image light beam S255 (which may be a collimated light beam) that propagates through the input pupil 257 of a viewing optics assembly.

In some examples, the imaging assembly 260 may also include a plurality of polarization conversion elements configured to convert a polarization state of the backlight or the image light. For example, the imaging assembly 260 may include a first quarter-wave plate 571a disposed between the first PBS 507 and the first curved mirror 509 (e.g., at a surface of the first PBS 507 facing the first curved mirror 509), a second quarter-wave plate 571b disposed between the second PBS 527 and the second curved mirror 529 (e.g., at a surface of the second PBS 527 facing the second curved mirror 529), and a third quarter-wave plate 571c disposed between the second PBS 527 and the display panel 220 (e.g., at a surface of the display panel 220 facing the second PBS 527). In some examples, the imaging assembly 260 may also include a first half-wave plate 573a disposed between the second PBS 527 and the first PBS 507 (e.g., at a surface of the second PBS 527 facing the first PBS 507), and a second half-wave plate 573b disposed between the second PBS 527 and the input pupil 257 (e.g., at a surface of the second PBS 527 facing the input pupil 257). In some examples, the imaging assembly 260 may also include a linear polarizer 575 disposed between the second half-wave plate 573b and the input pupil 257 of the viewing optics assembly (e.g., between the second half-wave plate 573b and the input pupil 257). The second half-wave plate 573b may be disposed between the linear polarizer 575 and the second PBS 527. The linear polarizer 575 may function as a clean-up polarizer.

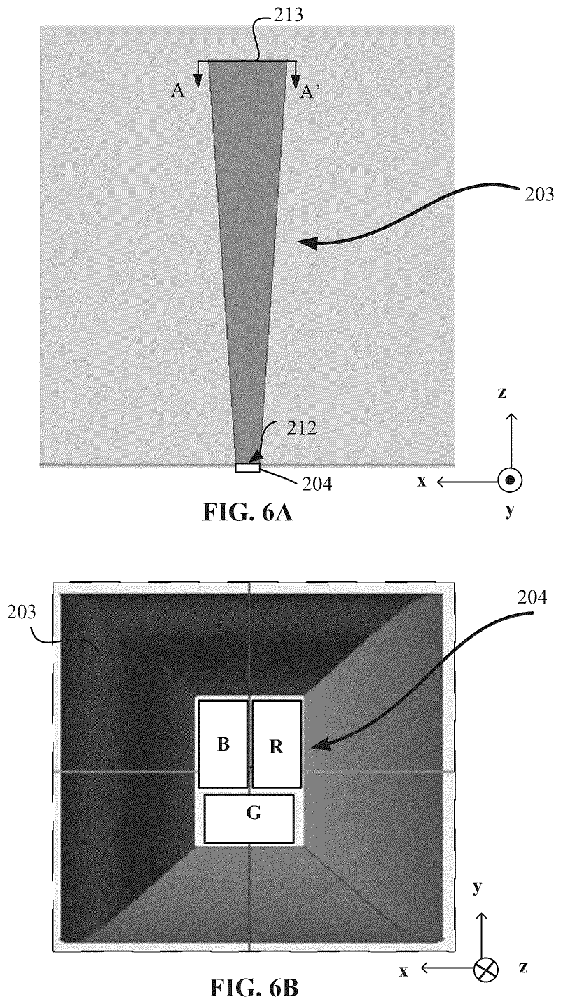

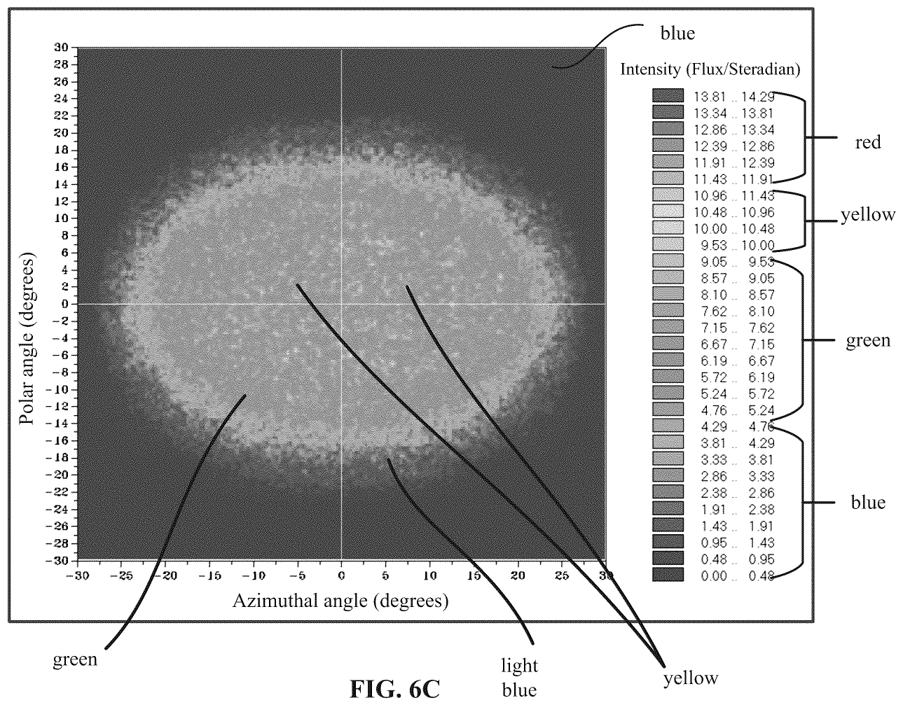

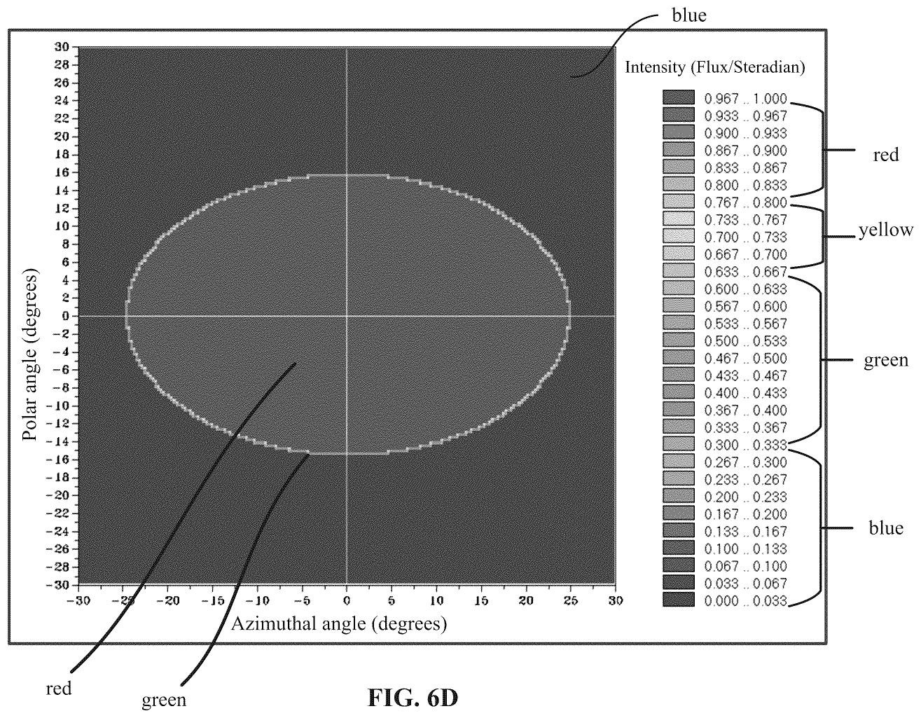

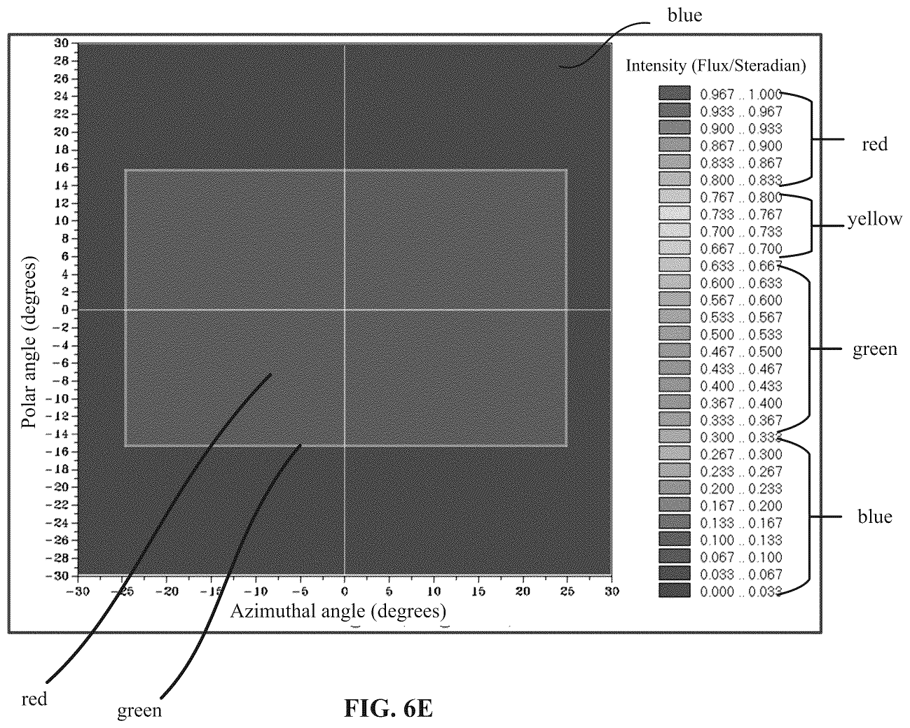

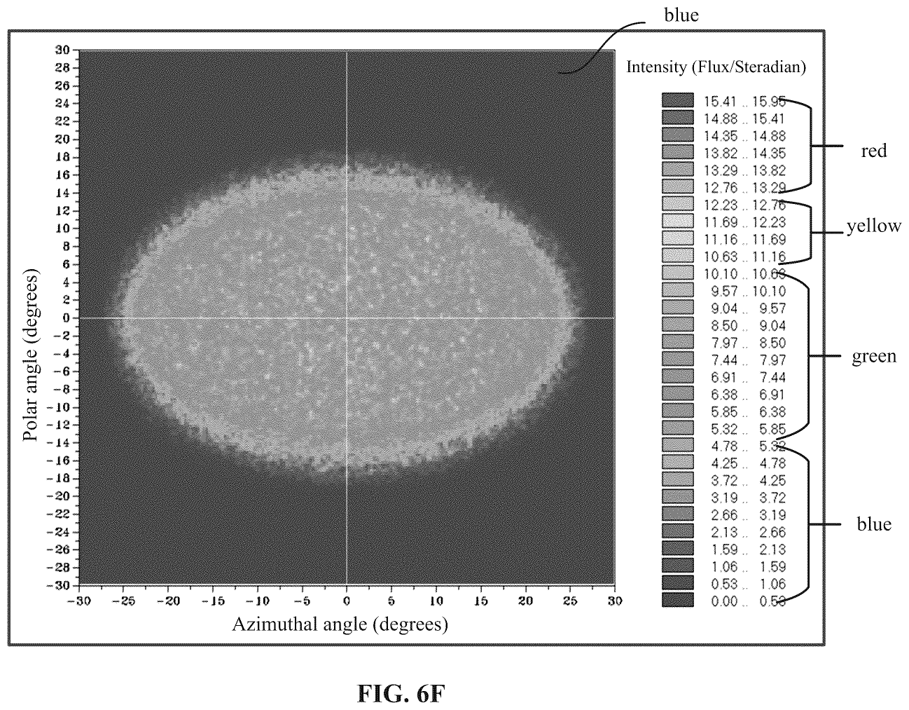

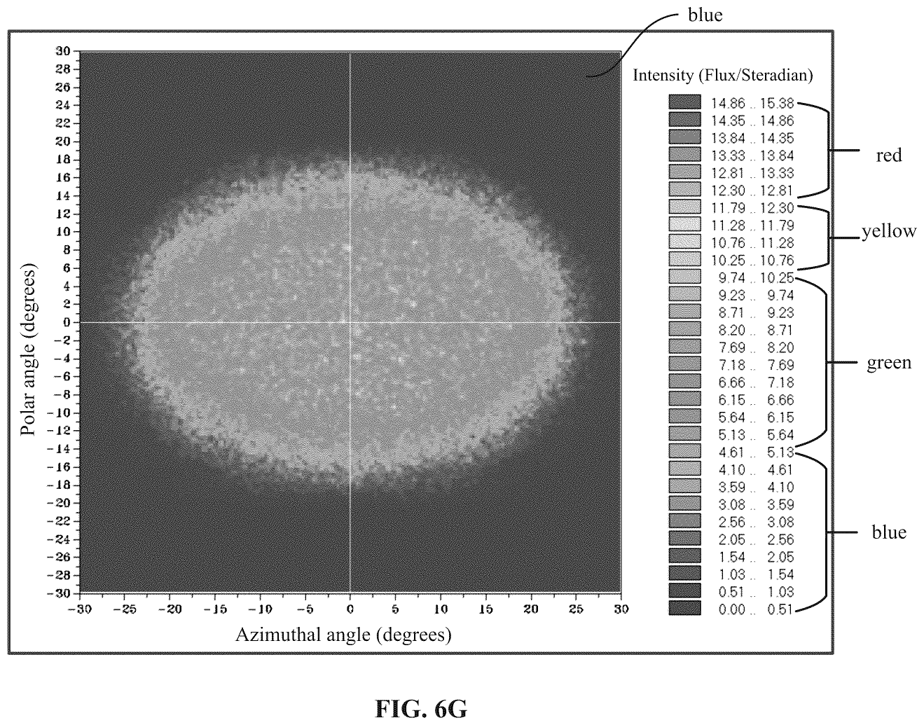

FIG. 6A illustrates a schematic diagram of an x-z cross section view of a single taper 203 coupled with a single illumination unit 204, and FIG. 6B illustrates an enlarged top view of the single taper 203 and the single illumination unit 204 along the A-A′ line shown in FIG. 6A. As shown in FIG. 6B, the color sub-zone configuration of the illumination unit 204 may be similar to that shown in FIG. 2C. That is, the illumination unit 204 may include three color sub-zones corresponding to three light sources: a green sub-zone (denoted as “G”) corresponding to a green light source (e.g., a green LED), a red sub-zone (denoted as “R”) corresponding to a red light source (e.g., a red LED), and a blue sub-zone (denoted as “B”) corresponding to a blue light source (e.g., a blue LED).

FIG. 6C-6E illustrate simulation results showing a relationship between an output emission angle of the concentrator (unit: degree) and an output radiant or intensity (unit: power (flux) per unit solid angle, or flux/steradian) of the taper 203 shown in FIG. 6A. The solid angle of the output emission is an integrated product of the output emission angles of the concentrator. In FIGS. 6C-6E, the taper 203 may be a solid PMMA taper with an anti-reflection coating at each of the input and exit facets. The side surface of the taper 203 may not have an anti-reflection coating. In FIGS. 6C-6E, the horizonal axis represents the azimuthal angle (unit: degree), and the vertical axis represents the polar angle (unit: degree), which are projected angles of the output emission angle of the concentrator. A color bar is shown to represent the output intensity (flux/steradian) at the exit aperture 213 of the taper 203. The blue zone denotes the lowest output intensity zone, the red zone denotes the highest output intensity zone, the yellow zone denotes the second highest output intensity zone, and the green zone denotes the third highest output intensity zone. In each color zone, a darker color denotes a higher output intensity, and a lighter color denotes a lower output intensity.

FIG. 6C illustrates simulation results showing output intensity at the exit aperture 213 of the taper 203. Baseline ensquared energy for the single taper using elliptical and rectangular masks is also calculated. The masks used for the ensquared energy may have their major and minor axes set to the design output angles for the taper 203. FIG. 6D illustrates simulation results showing output intensity at the exit aperture 213 of the taper 203, via an elliptical mask. FIG. 6E illustrates simulation results showing output intensity at the exit aperture 213 of the taper 203, via a rectangular mask. The calculated ensquared energy at the exit aperture 213 of the taper 203 with the elliptical mask is about 83%, and the calculated ensquared energy at the exit aperture 213 of the taper 203 with the rectangular mask is about 90%.

FIG. 6F illustrates simulation results showing a relationship between the polar angle (unit: degree) and the azimuthal angle (unit: degree) at various output intensities (unit: flux/steradian) of the taper 203 when the taper is a single hollow taper, according to an example of the present disclosure. The illumination unit 204 may be disposed within the entrance aperture 212 of the taper 203. The calculated ensquared energy at the exit aperture 213 of the taper 203 with the elliptical mask is about 90.7%, and the calculated ensquared energy at the exit aperture 213 of the taper 203 with the rectangular mask is about 95.9%.

FIG. 6G illustrates simulation results showing a relationship between the polar angle (unit: degree) and the azimuthal angle (unit: degree) at various output intensities (unit: flux/steradian) of the taper 203 when the taper is a single PMMA solid taper, according to an example of the present disclosure. The illumination unit 204 and the taper 203 may be spaced apart from one another by a 100 nm gap. The light beam output from the illumination unit 204 is coupled into a TIR path inside the taper 203. The calculated ensquared energy at the exit aperture 213 of the taper 203 with the elliptical mask is about 87.7%, and the calculated ensquared energy at the exit aperture 213 of the taper 203 with the rectangular mask is about 93.8%. The difference in throughput between the simulation of the single hollow taper shown in FIG. 6F and the simulation of the single solid taper in FIG. 6G may be due to the 100 nm offset of the illumination unit 204 from the entrance aperture 212 of the taper 203.

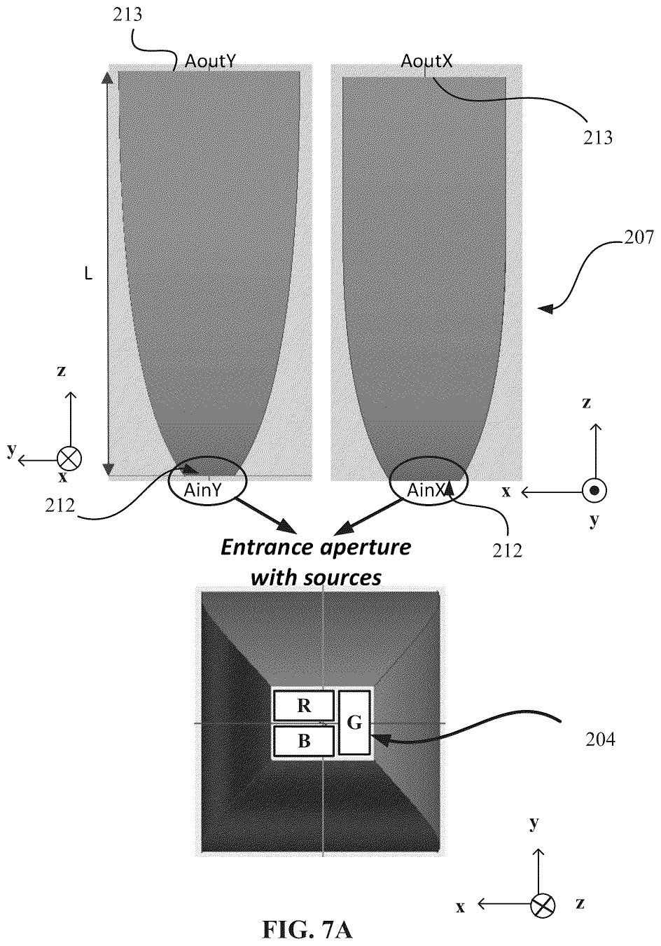

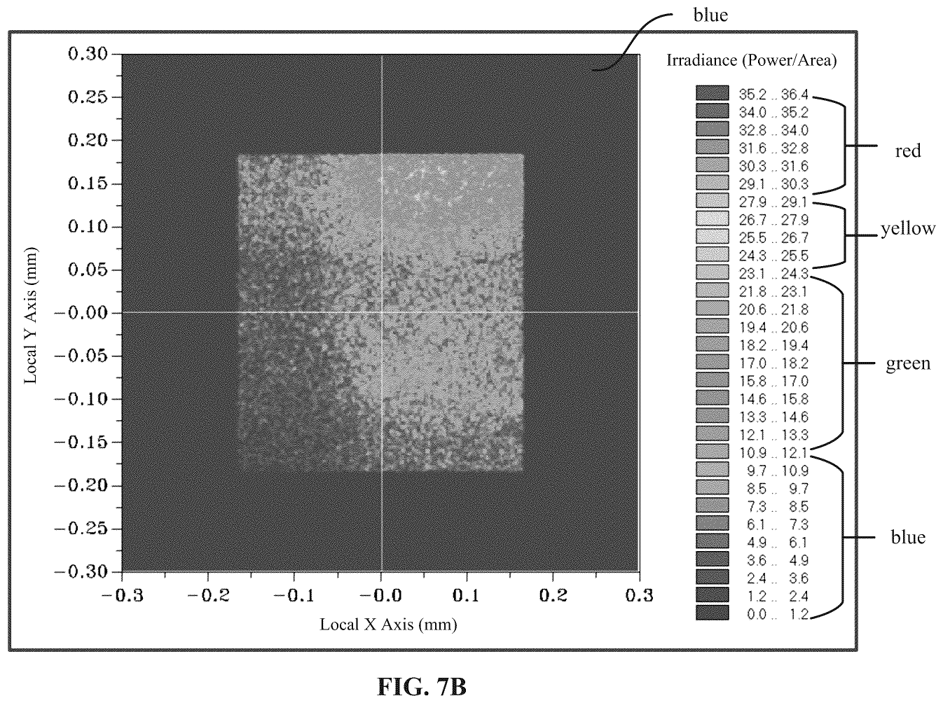

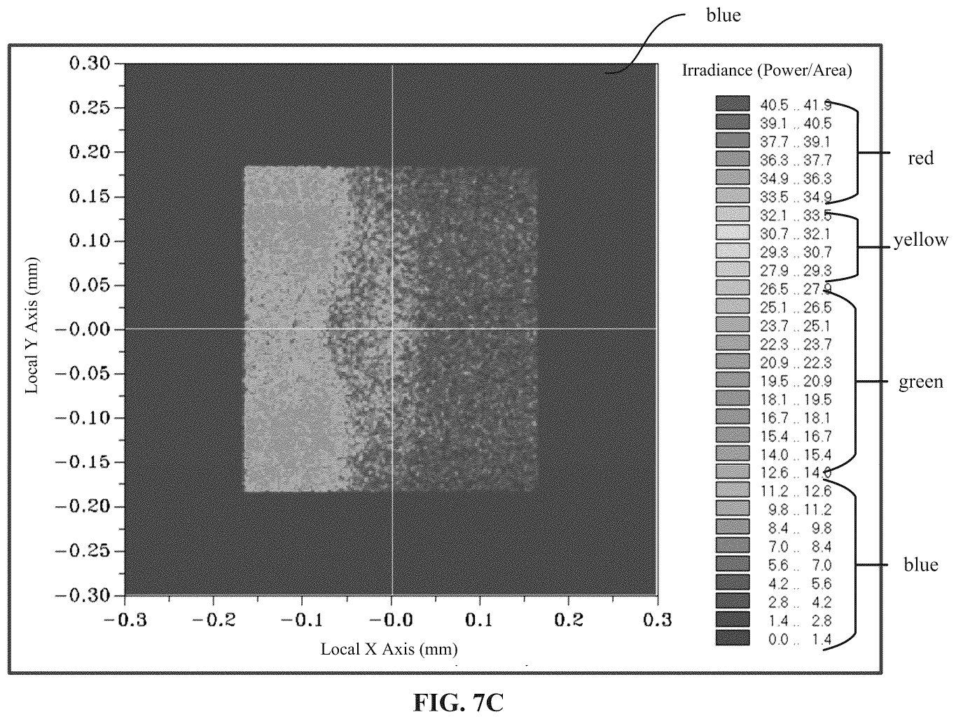

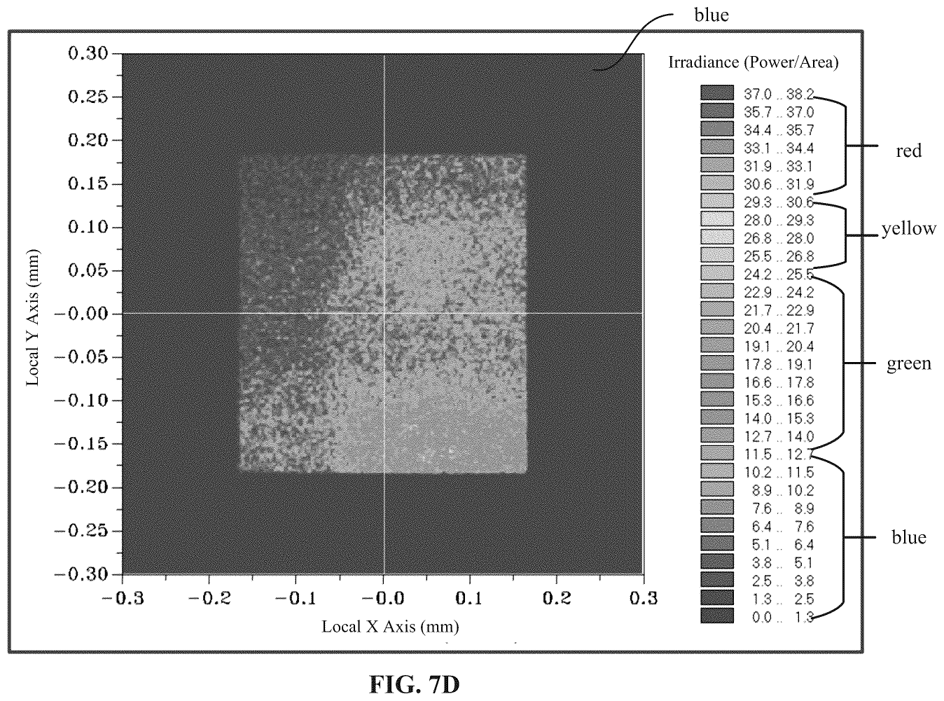

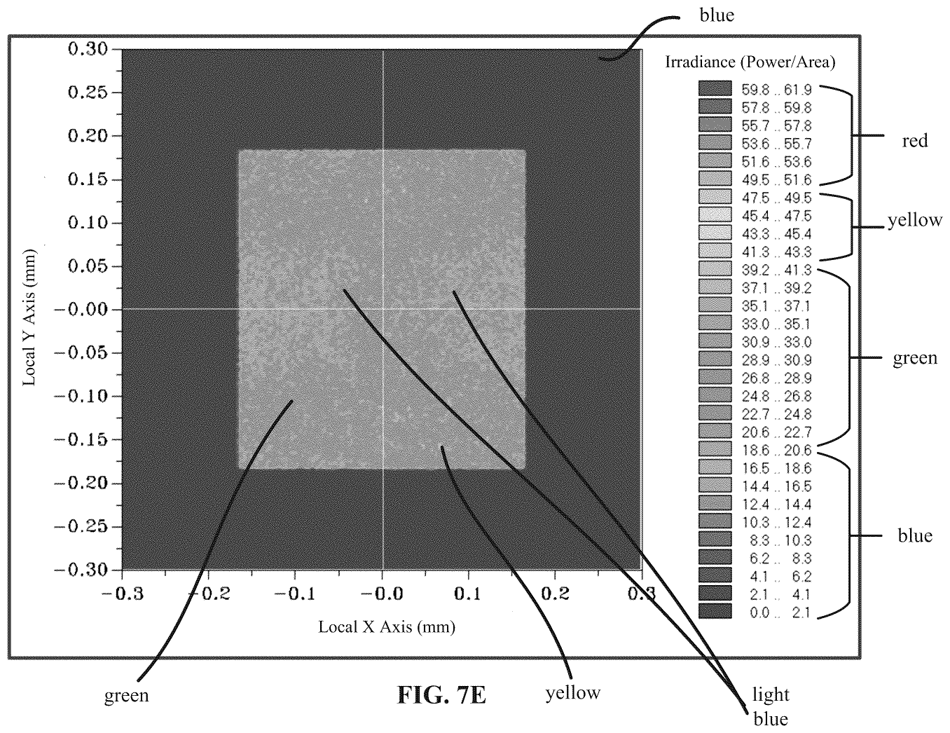

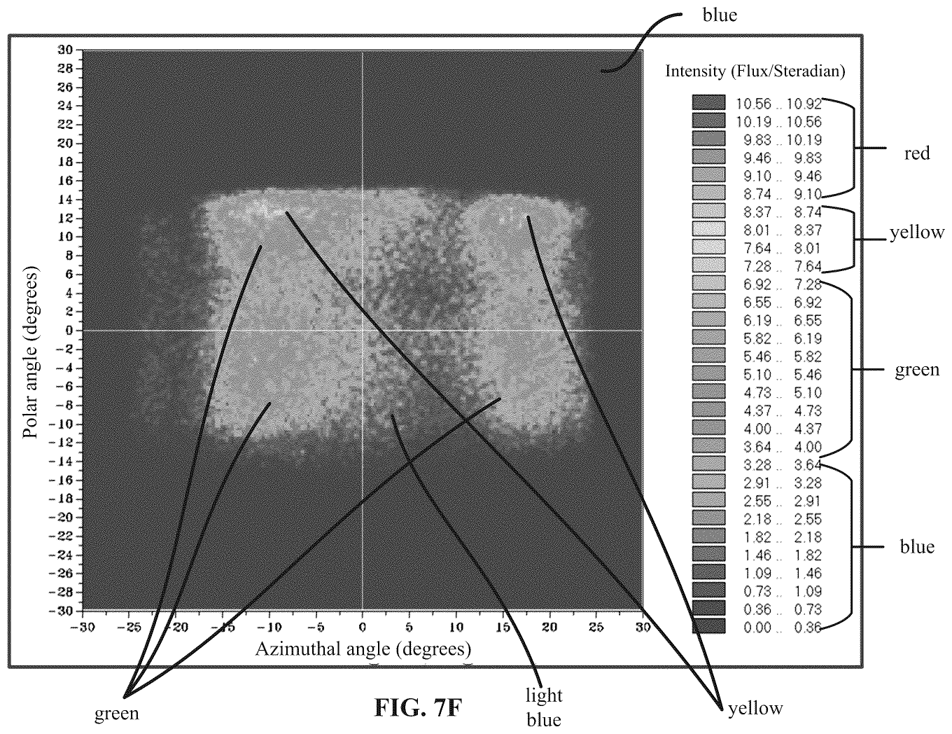

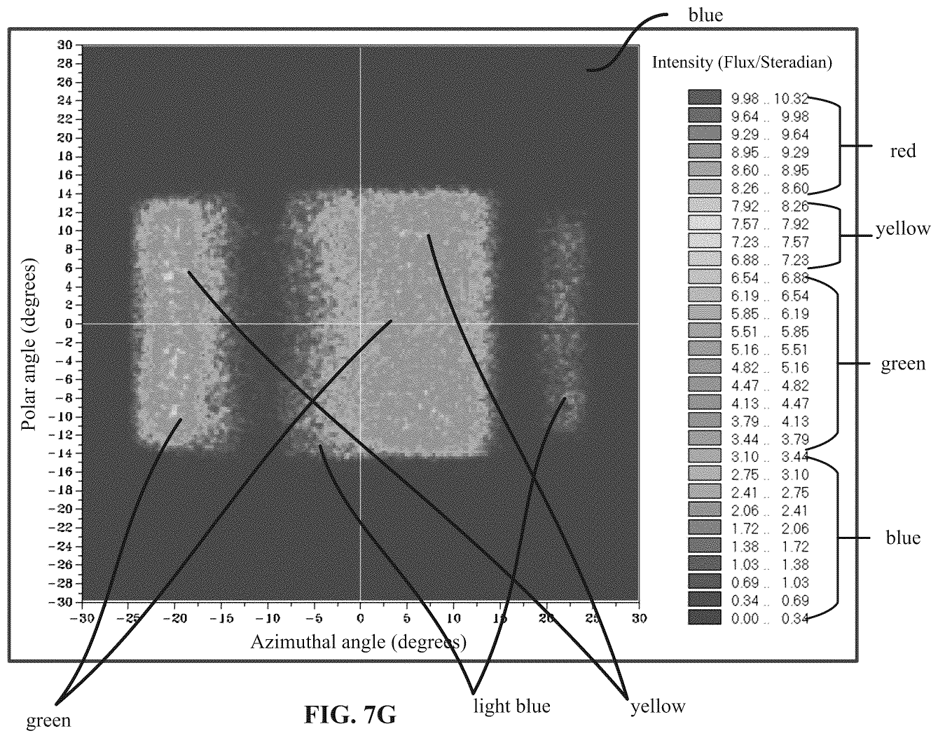

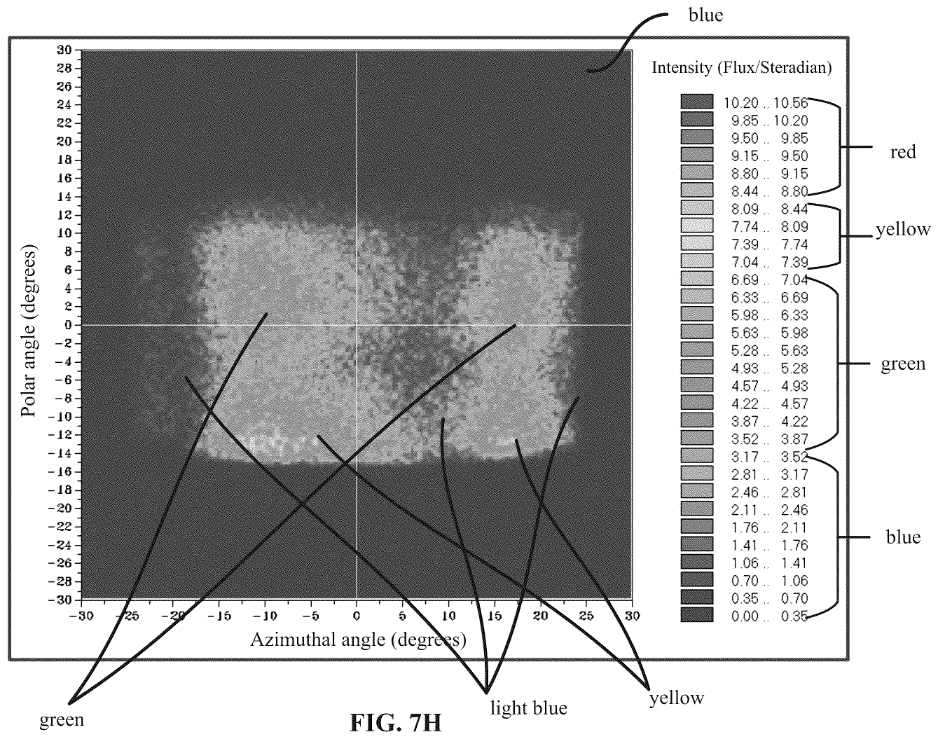

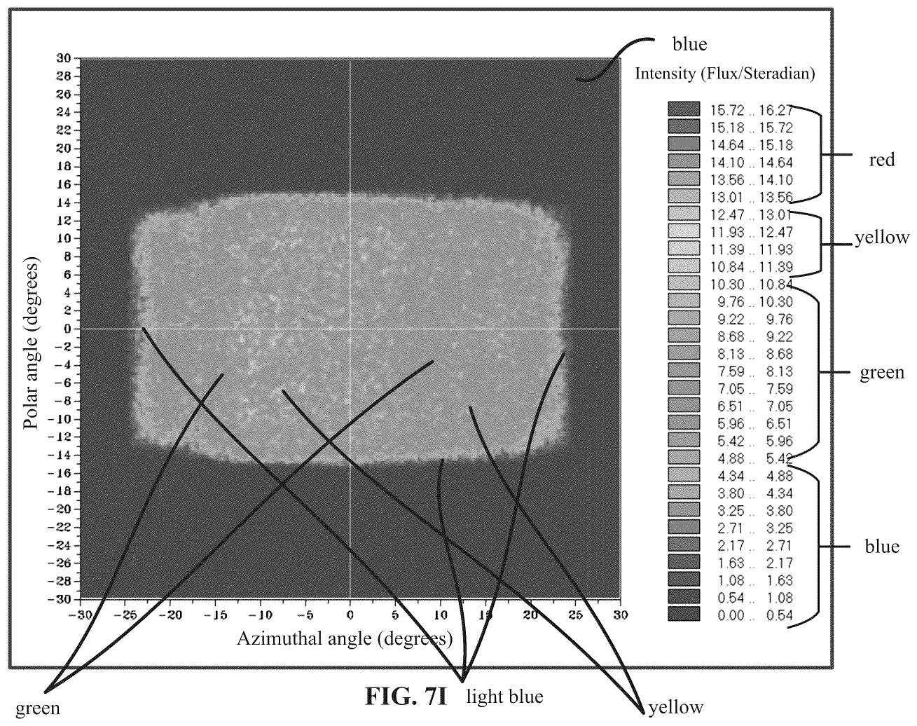

FIG. 7A illustrates a schematic diagram of a CPC 207 and an illumination unit 204 that may be included in the display system shown in FIG. 2A, according to an example of the present disclosure. As shown in FIG. 7A, the entrance aperture 212 and the exit aperture 213 of the CPC 207 may have rectangular cross sections with different widths along the x-axis and the y-axis (width “AinX” in the x-axis direction at the entrance aperture 212, width “AinY” in the y-axis direction at the entrance aperture 212, width “AoutX” in the x-axis direction at the exit aperture 213, and width “AoutY” in the y-axis direction at the exit aperture 213). The color sub-zone configuration of the illumination unit 204 may be similar to that shown in FIG. 2C. The color sub-zones of the illumination unit 204 may output a red light beam, a green light beam, and a blue light beam, respectively, which together may form a white light beam propagating toward the CPC 207.

FIGS. 7B-7D illustrate simulation results showing output irradiance (in terms of power per area) at the exit aperture 213 the CPC 207 for the red light beam, the green light beam, and the blue light beam, respectively. FIG. 7E illustrates simulation results showing output irradiance (in terms of power per area) at the exit aperture 213 the CPC 207 for the white light beam. As shown in FIGS. 7B-7E, the respective output irradiances at the exit aperture 213 the CPC 207 for the red light beam, the green light beam, and the blue light beam may exhibit non-uniformities that are highly correlated with the respective placements of the red, green, and blue light sources (or the color sub-zones). As shown in FIG. 7E, the output irradiance at the exit aperture 213 the CPC 207 for the white light beam may be substantially uniform over the exit aperture 213.

FIGS. 7F-7H illustrate simulation results showing a relationship between an output emission angle of the concentrator (unit: degree) and an output radiant or intensity (unit: power (flux) per unit solid angle, or flux/steradian) of the CPC 207 for the red light beam, the green light beam, and the blue light beam output from the illumination unit 204, respectively. FIG. 71 illustrates simulation results showing a relationship between an output emission angle of the concentrator (unit: degree) and an output radiant or intensity (unit: power (flux) per unit solid angle, or flux/steradian) of the CPC 207 for the white light beam. As shown in FIGS. 7F-7H, the respective output intensities for the red light beam, the green light beam, and the blue light beam may exhibit non-uniformities that are highly correlated with the respective placements of the red, green, and blue light sources. As shown in FIG. 71, the output intensity at the exit aperture 213 the CPC 207 for the white light beam may be substantially uniform over the design solid angle. The ensquared energy over the design solid angle of the CPC 207 is calculated as 100% for anti-reflective coatings disposed at the CPC 207 because the CPC is an etendue conserving element.

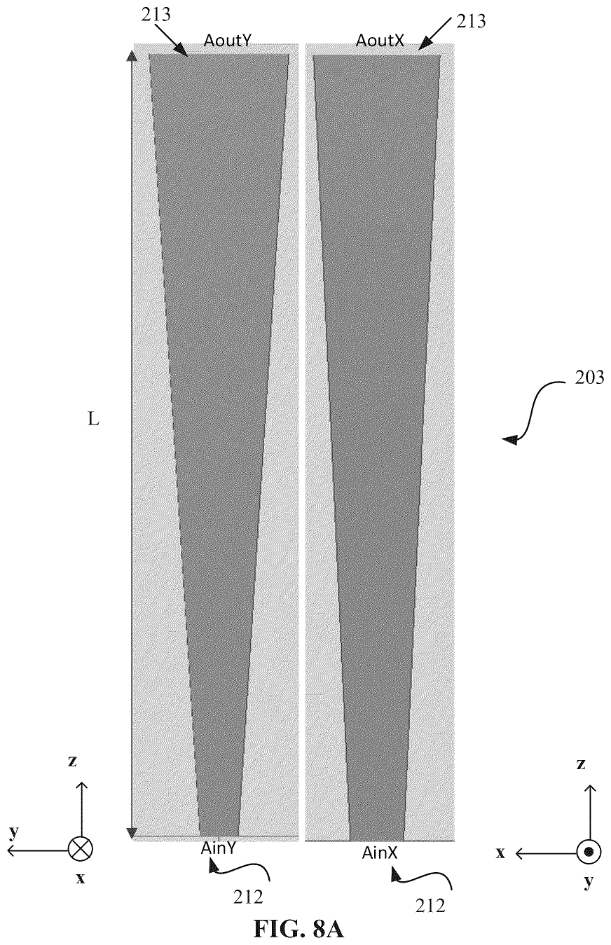

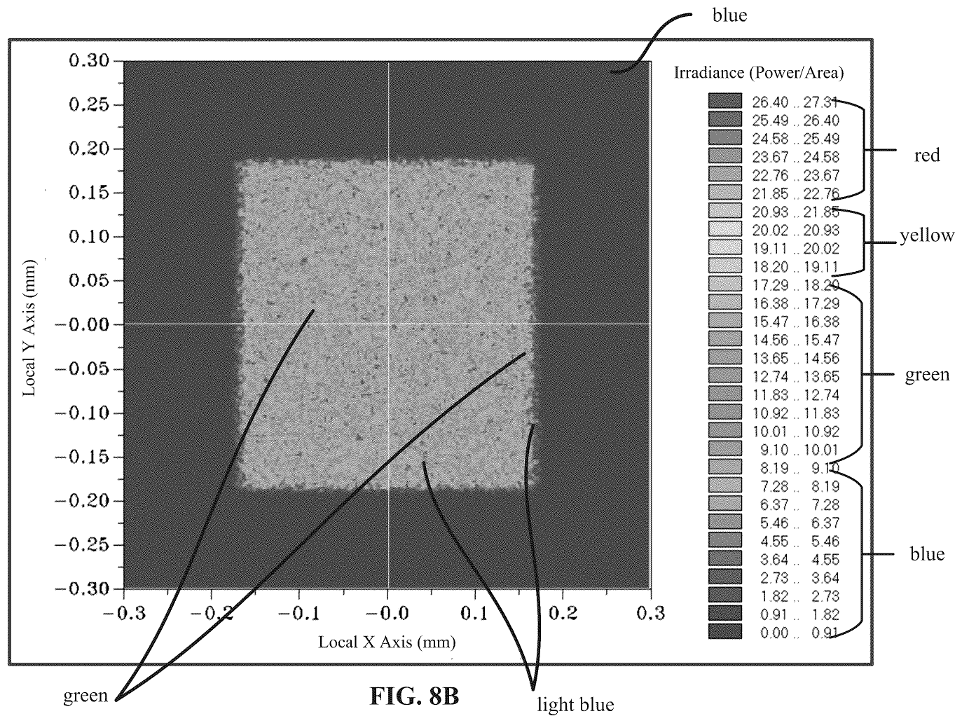

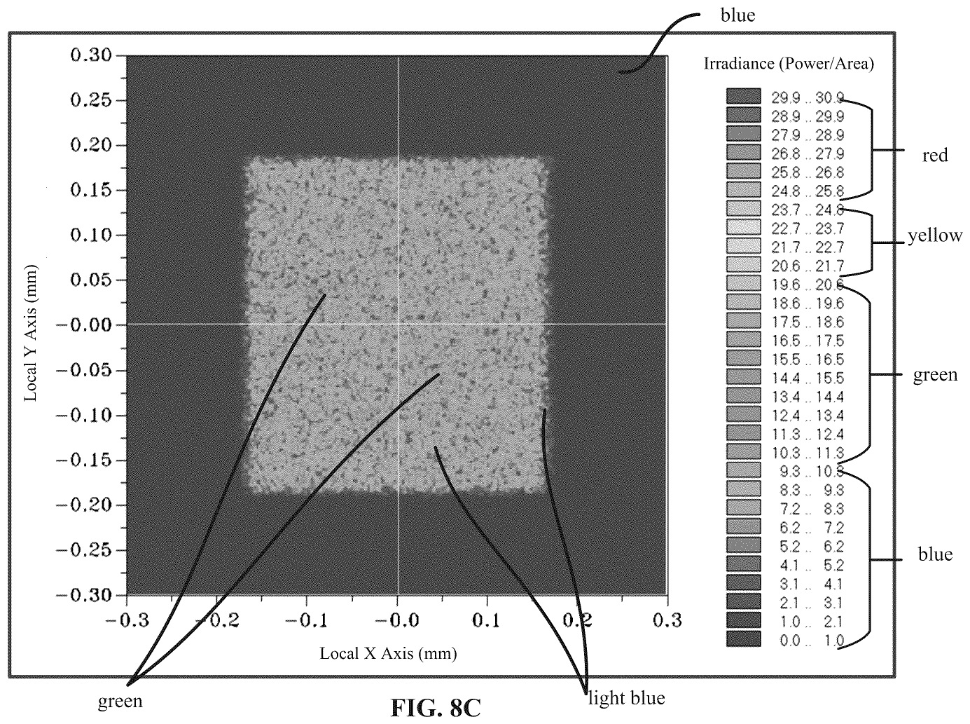

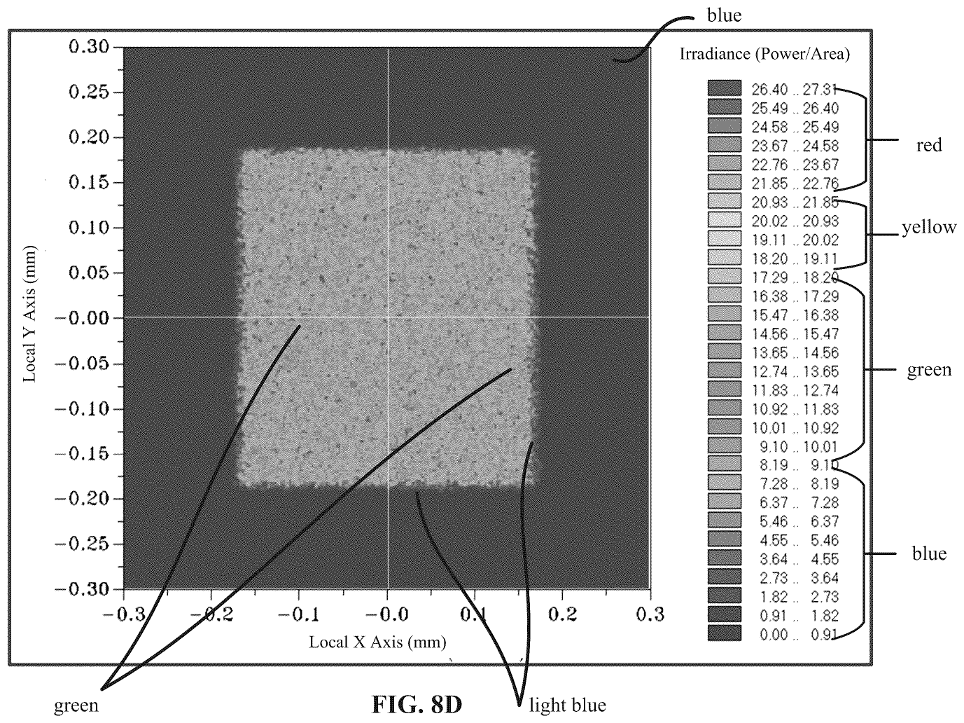

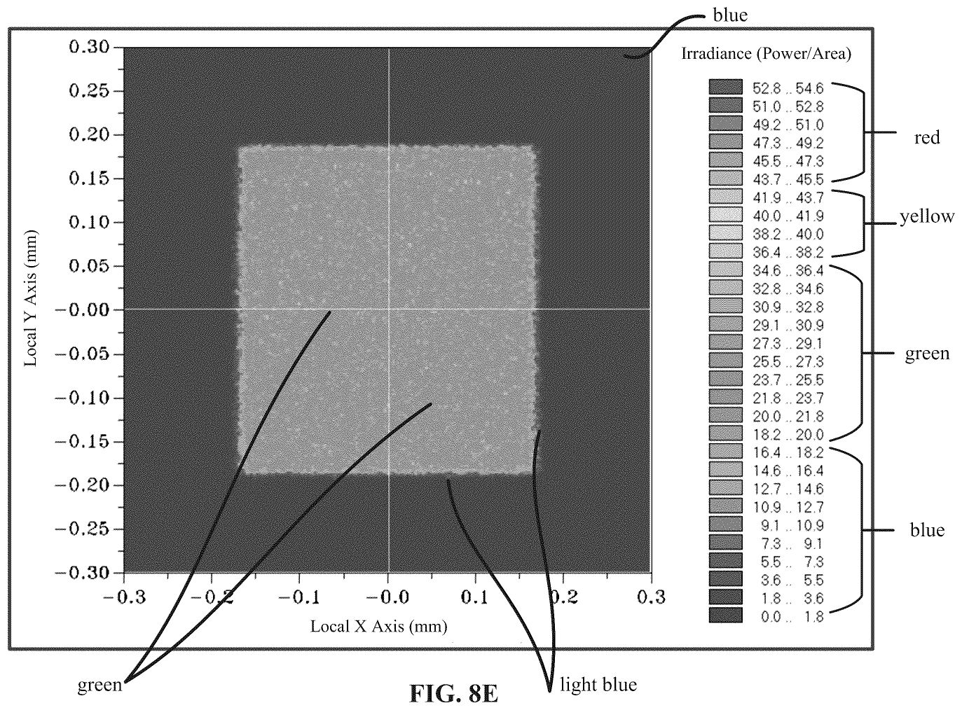

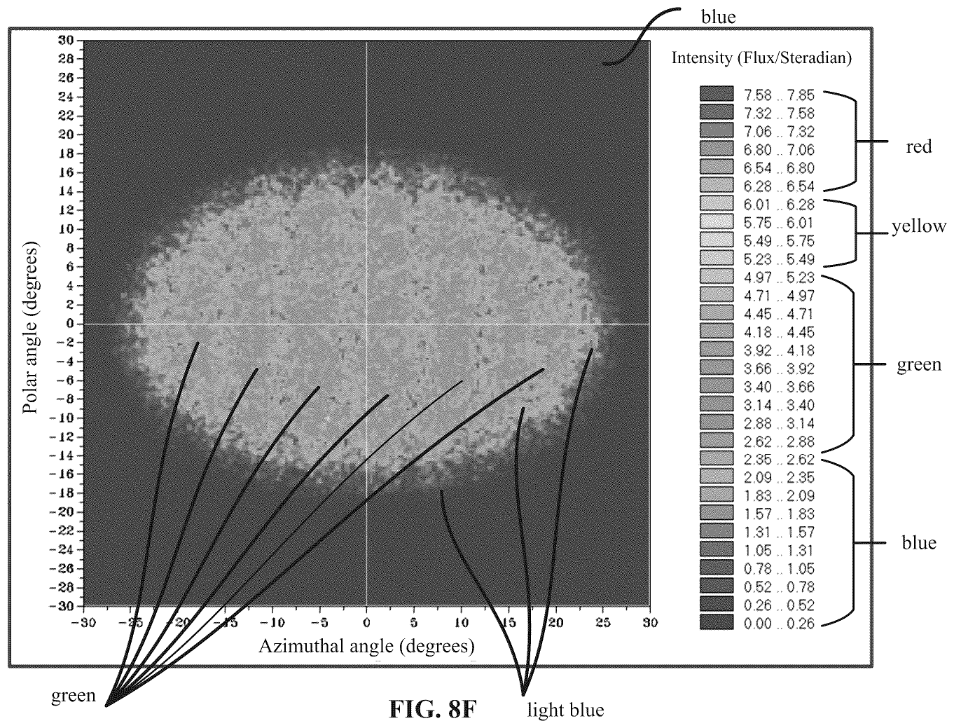

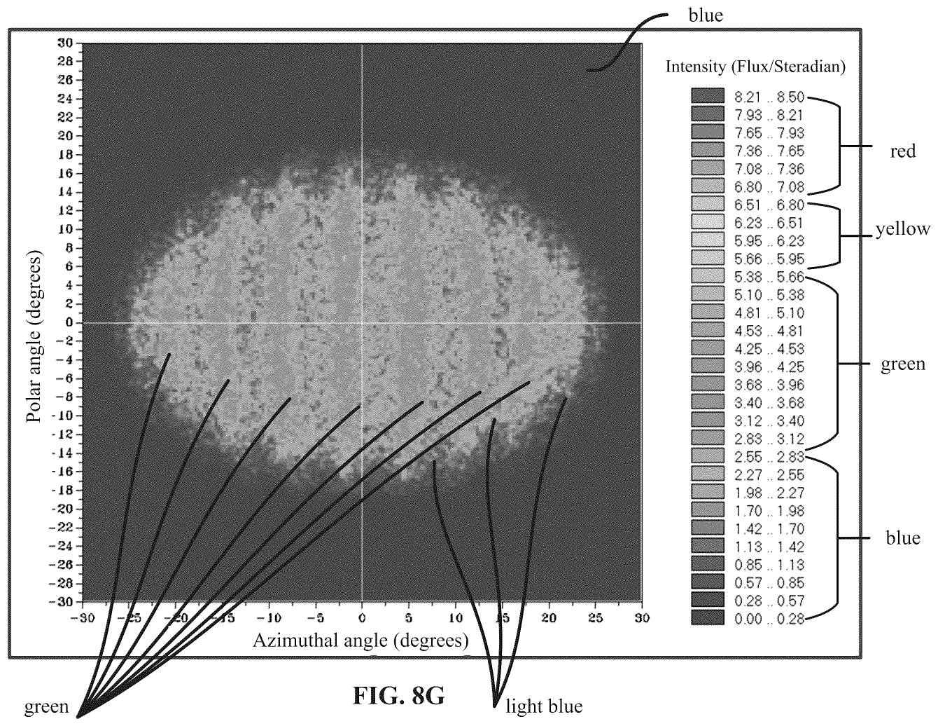

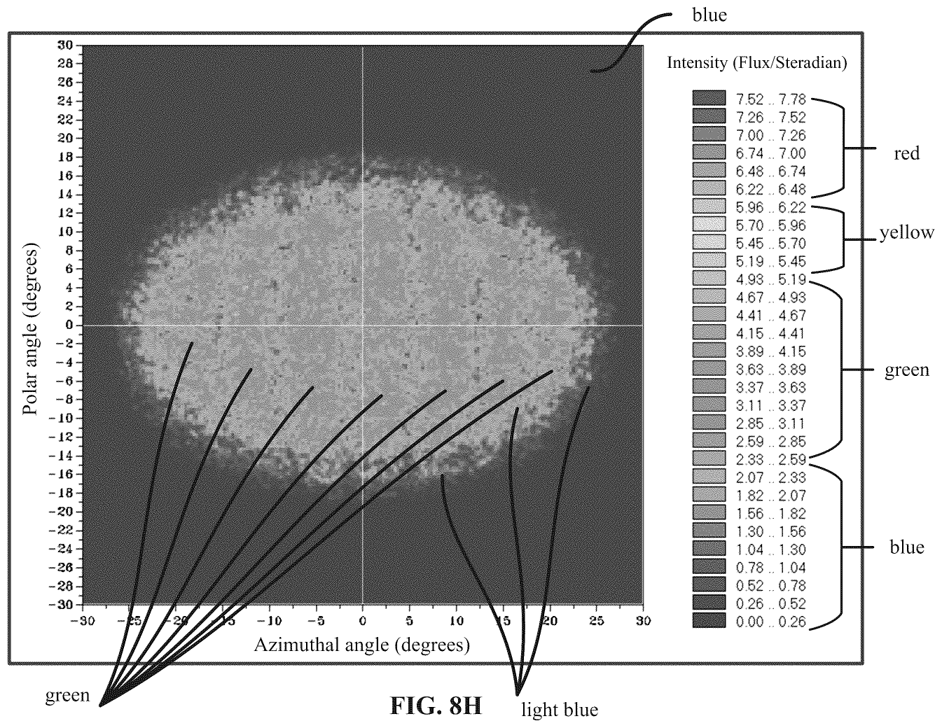

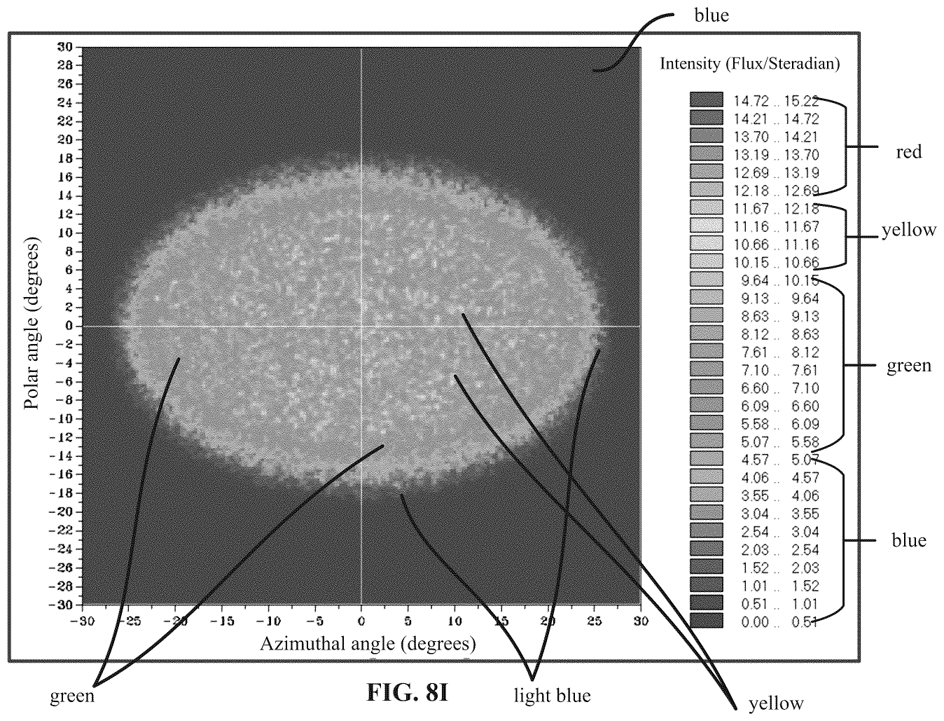

FIG. 8A illustrates a schematic diagram of a taper 203 and an illumination unit 204 that may be included in the display system 200 shown in FIG. 2A, according to an example of the present disclosure. As shown in FIG. 8A, the taper 203 may have a rectangular cross section with different widths along the x-axis and the y-axis of the entrance aperture 212 and the exit aperture 213 (width “AinX” in x-axis direction at the entrance aperture 212, width “AinY” in y-axis direction at the entrance aperture 212, width “AoutX” in x-axis direction at the exit aperture 213, width “AoutY” in y-axis direction at the exit aperture 213). The height L of the taper 203 along the z-axis may be approximately 5-7 times of the width of the exit aperture 213. The color sub-zone configuration of the illumination unit 204 may be similar to that shown in FIG. 2C. The color sub-zones of the illumination unit 204 may output a red light beam, a green light beam, and a blue light beam, respectively, which together may form a white light beam propagating toward the taper 203.

FIGS. 8B-8D illustrate simulation results showing output irradiance (in terms of power per area) at the exit aperture 213 of the taper 203 for the red light beam, the green light beam, and the blue light beam, respectively. FIG. 8E illustrates simulation results showing output irradiance (in terms of power per area) at the exit aperture 213 of the taper 203 for the white light beam. As shown in FIGS. 8B-8E, the respective output irradiances at the exit aperture 213 of the taper 203 for the red light beam, the green light beam, the blue light beam, and the white beam may be substantially uniform over the design solid angle.

FIGS. 8F-8H illustrate simulation results showing a relationship between an output emission angle of the concentrator (unit: degree) and an output radiant or intensity (unit: power (flux) per unit solid angle, or flux/steradian) of the taper 203 for the red light beam, the green light beam, and the blue light beam output from the illumination unit 204, respectively. FIG. 8I illustrates simulation results showing a relationship between an output emission angle of the concentrator (unit: degree) and an output radiant or intensity (unit: power (flux) per unit solid angle, or flux/steradian) of the taper 203 for the white light beam. As shown in FIGS. 8F-8H, over the design solid angle of the taper 203, the respective output intensities for the red light beam, the green light beam, and the blue light beam may have mid frequency structure along the narrowest section of the exit aperture 213. As shown in FIG. 81, the output intensity at the exit aperture 213 of the taper 203 for the white light beam may exhibit a high uniformity over the design solid angle. The ensquared energy over the design solid angle of the taper 203 is calculated as about 91% for anti-reflective coatings disposed at the taper 203.

Any of the steps, operations, or processes described herein may be performed or implemented with one or more hardware and/or software modules, alone or in combination with other devices. A software module may be implemented with a computer program product including a computer-readable medium containing computer program code, which can be executed by a computer processor for performing any or all of the steps, operations, or processes described. In some examples, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. An illumination system for a non-emissive display panel, comprising:
a light source array including a plurality of individually addressable illumination units, an illumination unit being configured to emit a first light beam having a first solid angle;
a concentrator array coupled with the light source array and including a plurality of concentrators, a concentrator being configured to condition the first light beam into a second light beam associated with a second solid angle that is smaller than the first solid angle, the second light beam providing a substantially uniform illumination at an exit aperture of the concentrator; and
an imaging assembly including one or more optical elements configured to image the substantially uniform illumination at the exit aperture of the concentrator onto the non-emissive display panel.

2. The illumination system of claim 1, wherein the concentrator includes an input facet at a location where an entrance aperture of the concentrator is located, an output facet at a location where the exit aperture of the concentrator is located, and a concentrator body disposed between the input facet and the output facet, and wherein an area of the input facet is smaller than an area of the output facet.

3. The illumination system of claim 2, wherein the concentrator body includes at least one of a curved body portion or an angularly shaped body portion.

4. The illumination system of claim 3, wherein the concentrator body further includes a straight body portion.

5. The illumination system of claim 2, wherein an anti-reflection coating is disposed at each of the input facet and the exit facet of the concentrator.

6. The illumination system of claim 1, wherein the concentrator includes a concentrator body having a cavity surrounded by a wall, and wherein the concentrator is configured to guide the first light beam to propagate therethrough via reflection at the wall surrounding the cavity.

7. The illumination system of claim 1, wherein the concentrator includes a solid concentrator body configured to guide the first light beam to propagate therethrough via total internal reflection at a side surface of the solid concentrator body, and wherein the solid concentrator body is made of an isotropic and homogeneous dielectric material having an isotropic and homogenous refractive index.

8. The illumination system of claim 1, wherein the concentrator includes a compound parabolic concentrator (“CPC”).

9. The illumination system of claim 8, wherein
the CPC includes an input facet where an entrance aperture of the CPC is located, an output facet where the exit aperture of the CPC is located, and a concentrator body disposed between the input facet and the output facet; and
the concentrator body has a truncated paraboloid shape.

10. The illumination system of claim 9, wherein the first light beam is configured to enter the CPC through the entrance aperture, undergo a single reflection at the concentrator body, and exit the CPC through the exit aperture.

11. The illumination system of claim 1, wherein the concentrator includes a taper.

12. The illumination system of claim 11, wherein
the taper includes an input facet where an entrance aperture of the taper is located, an output facet where the exit aperture of the taper is located, and a concentrator body disposed between the input facet and the output facet; and
the concentrator body has a truncated cone shape or truncated pyramid shape.

13. The illumination system of claim 12, wherein the first light beam is configured to enter the taper through the entrance aperture, undergo multiple reflections at a side surface of the concentrator body, and exit the taper through the exit aperture.

14. The illumination system of claim 11, wherein the taper is configured with a height that is about 5 to 7 times of a width of the exit aperture.

15. The illumination system of claim 1, wherein the concentrator includes one or more of cyclic olefin copolymer, cyclic olefin polymer, polycarbonate, polymethyl methacrylate, polyethylene, polyurethane, or polypropylene.

16. The illumination system of claim 1, wherein the illumination unit is disposed adjacent to an entrance aperture of the concentrator.

17. The illumination system of claim 1, wherein the illumination unit includes at least one red light source, at least one green light source, and at least one blue light source.

18. The illumination system of claim 1, wherein the plurality of concentrators correspond to the plurality of individually addressable illumination units, respectively.
